(19) United States
(12) Patent Application Publication
(10) Pub. No.: US 2025/0356207 A1
(43) Pub. Date: Nov. 20, 2025

(54) TRAINING A REINFORCEMENT LEARNING MACHINE LEARNING MODEL

(71) Applicant: Royal Bank of Canada, Toronto (CA)

(72) Inventors: Tristan SYLVAIN, Montreal (CA); Raihan SERAJ, Montreal (CA); Lili MENG, Vancouver (CA)

(21) Appl. No.: 19/042,673

(22) Filed: Jan. 31, 2025

Related U.S. Application Data
(60) Provisional application No. 63/649,019, filed on May 17, 2024.

(51) Int. Cl. G06N 3/092

(52) U.S. Cl. CPC G06N 3/092

(57) ABSTRACT

One or more computer processors are used to train a reinforcement learning machine learning model, such as a contextual bandit machine learning model. A training dataset is inputted to the reinforcement learning machine learning model. The reinforcement learning machine learning model is trained based on the training dataset. During the training, an entropy of the reinforcement learning machine learning model is determined. Based on the feedback, feedback is generated. The reinforcement learning machine learning model is further trained based on the feedback.

### FIELD

The present disclosure relates to machine learning and in particular to methods and systems for training a reinforcement learning machine learning model, such as a contextual bandit machine learning model.

### BACKGROUND

A contextual bandit machine learning model (“contextual bandit”) is a machine learning model designed to solve a contextual bandit problem. In a contextual bandit problem, an agent (or algorithm) is presented with a series of different situations or (or “contexts”) and must choose an action for each context. Each action yields a reward, but the reward depends on both the action taken and the context in which the action is taken. The goal of the agent is to learn a policy that maximizes cumulative reward over time, despite initially having limited or no knowledge of the environment. The term “bandit” comes from the idea of a gambler facing a row of slot machines (bandits), each with unknown reward probabilities. The “contextual” aspect refers to the fact that the agent receives additional information about the environment before making each decision.

Contextual bandits are commonly used in personalized recommendation systems, online advertising, and other applications where decisions must be made in real-time and based on limited available information. In addition, a contextual bandit's adaptability makes it a valuable tool for enhancing a wide array of machine learning methods, including supervised learning, unsupervised learning, active learning, and reinforcement learning. They are particularly useful when the environment is dynamic and uncertain, as they allow for adaptive decision-making.

Despite advancements in algorithmic strategies, the field of contextual bandits is predominantly characterized by reliance on implicit feedback, such as user clicks, which often results in biased and incomplete evaluations of user preferences and behaviors. This reliance on implicit feedback poses significant challenges in accurately gauging user responses and tailoring the learning process accordingly.

### SUMMARY

According to a first aspect of the disclosure, there is provided a method of using one or more computer processors to train a reinforcement learning machine learning model, comprising using the one or more computer processors to: input a training dataset to the reinforcement learning machine learning model; train the reinforcement learning machine learning model based on the training dataset; determine, during the training, an entropy of the reinforcement learning machine learning model; generate feedback based on the entropy; and further train the reinforcement learning machine learning model based on the feedback.

The reinforcement learning machine learning model may be a contextual bandit machine learning model.

During the training, the contextual bandit machine learning model may be configured to maximize the function

$${max}_{{u}_{t} ∼ π} {\sum }_{t = 1}^{T} 𝔼 [ {r}_{t} ( {u}_{t} ) \vert {s}_{t} , {u}_{t} ] ,$$

wherein E is the expected value, rₜ(uₜ) is a reward function at time t and which depends on an action uₜ, and sₜ is a state at time t.

Determining the entropy may comprise: determining a number of actions that may be selected by the reinforcement learning machine learning model and respective probabilities of the reinforcement learning machine learning model selecting each action; and calculating H(p)=Σᵢpᵢ log₂ pᵢ, wherein H is the entropy and pᵢ is the probability of selecting the i^{th} action.

Generating the feedback may comprise: determining a threshold; and in response to determining that the entropy has exceeded the threshold, generating the feedback.

Generating the feedback may comprise: determining a total number of actions that may be selected by the reinforcement learning machine learning model; and restricting the total number of actions that may be selected by the reinforcement learning machine learning model.

Restricting the total number of actions may comprise restricting the number of actions that may be selected by the reinforcement learning machine learning model to a number q of actions, wherein q is less than or equal to the number of actions that may be selected divided by 2.

Generating the feedback may comprise: determining that the reinforcement learning machine learning model has selected an action from among a number of different possible actions, including one or more recommended actions; determining that the selected action is not a recommended action; and in response to determining that the selected action is not a recommended action, applying a reward penalty to a reward signal of the reinforcement learning machine learning model.

Applying the reward penalty may comprise reducing a reward that would otherwise have been applied to the reward signal in response to determining that the selected action is a recommended action.

Generating the feedback may comprise: determining an accuracy level to be associated with the feedback; and generating the feedback based on the accuracy level. In response to generating the feedback: the reinforcement learning machine learning model may select an action from among a number of different possible actions; and a reward generated based on the selected action may be more likely to be higher when the accuracy level associated with the feedback is relatively higher than when the accuracy level associated with the feedback is relatively lower.

Generating the feedback may comprise: during the training, determining a number of different possible actions that may be selected by the reinforcement learning machine learning model; inputting the different possible actions to a neural network trained to generate feedback based on different possible actions; and generating the feedback using the trained neural network.

The trained neural network may be a trained multi-layer perceptron.

According to a further aspect of the disclosure, there is provided a non-transitory, computer-readable storage medium storing computer program code configured, when executed by one or more processors, to cause the one or more processors to train a reinforcement learning machine learning model by performing the steps of any one of the above-described methods.

According to a further aspect of the disclosure, there is provided a method of using a reinforcement learning machine learning model, wherein the reinforcement learning machine learning model has been trained according to any one of the above-described methods.

Using the reinforcement learning machine learning model may comprise: detecting one or more user inputs; using the trained reinforcement learning machine learning model to generate, based on the one or more user inputs, one or more advertisements; and causing the one or more advertisements to be displayed on a user interface.

According to a further aspect of the disclosure, there is provided a method of using one or more computer processors to train a contextual bandit machine learning model, comprising using the one or more computer processors to: input a training dataset to the contextual bandit machine learning model; train the contextual bandit machine learning model based on the training dataset; generate feedback during the training; and further train the contextual bandit machine learning model based on the feedback.

Generating the feedback may comprise: determining that one or more training epochs have expired; and in response to determining that the one or more training epochs have expired, generating the feedback.

Generating the feedback may comprise: determine, during the training, an entropy of the contextual bandit machine learning model; and generate the feedback based on the entropy.

This summary does not necessarily describe the entire scope of all aspects. Other aspects, features and advantages will be apparent to those of ordinary skill in the art upon review of the following description of specific embodiments.

### DRAWINGS

Embodiments of the disclosure will now be described in detail in conjunction with the accompanying drawings of which:

FIGS. 1-4 show Kernel Density Estimation (KDE) plots according to different datasets and different contextual bandits, according to embodiments of the disclosure;

FIGS. 5-12 are plots of model performance based on different levels of experts and different datasets, according to embodiments of the disclosure;

FIGS. 13-20 are plots comparing the Proximal Policy Optimization (PPO) model's accuracy using entropy-based feedback and based on different datasets, according to embodiments of the disclosure;

FIGS. 21-28 are plots comparing the Proximal Policy Optimization-Long Short-Term Memory (PPO-LSTM) model's accuracy using entropy-based feedback and based on different datasets, according to embodiments of the disclosure;

FIGS. 29-36 are plots comparing the Reinforce model's accuracy using entropy-based feedback and based on different datasets, according to embodiments of the disclosure;

FIGS. 37-44 are plots comparing the Linear Upper Confidence Bound (Linear UCB) model's accuracy using entropy-based feedback and based on different datasets, according to embodiments of the disclosure;

FIG. 45 is a flow diagram showing a method of training a reinforcement learning machine learning model, according to an embodiment of the disclosure; and

FIG. 46 is a schematic diagram of a computer system that may be used to train a contextual bandit machine learning model, according to an embodiment of the disclosure.

### DETAILED DESCRIPTION

The present disclosure seeks to provide novel methods and systems for training a reinforcement learning machine learning model. While various embodiments of the disclosure are described below, the disclosure is not limited to these embodiments, and variations of these embodiments may well fall within the scope of the disclosure which is to be limited only by the appended claims.

Human-in-the-loop reinforcement learning offers a promising approach for training contextual bandits, by incorporating human guidance into the learning process. The concept involves humans playing an interactive and iterative role in a model's development. The benefit of human feedback in the context of a contextual bandit arises from the inherent complexity in certain decision-making aspects which often involve subjective or qualitative evaluations not easily captured by data. As such, human input may be useful to better understand such nuances, thereby enhancing the model's decision-making process.

According to embodiments of the disclosure, there are described herein methods and systems for training a contextual bandit machine learning model. The methods and systems described herein may be additionally beneficial in training, more generally, reinforcement learning machine learning models.

One advantage of the methods described herein is the direct acquisition of feedback from humans, as opposed to deducing reward functions from human preferences. While some studies have focused on preference-based learning—where humans express a preference for one action over another—the methods described herein may involve actively seeking human input to guide the agent's choices. This direct involvement allows for a more nuanced and immediate integration of human judgment into the model's decision-making process.

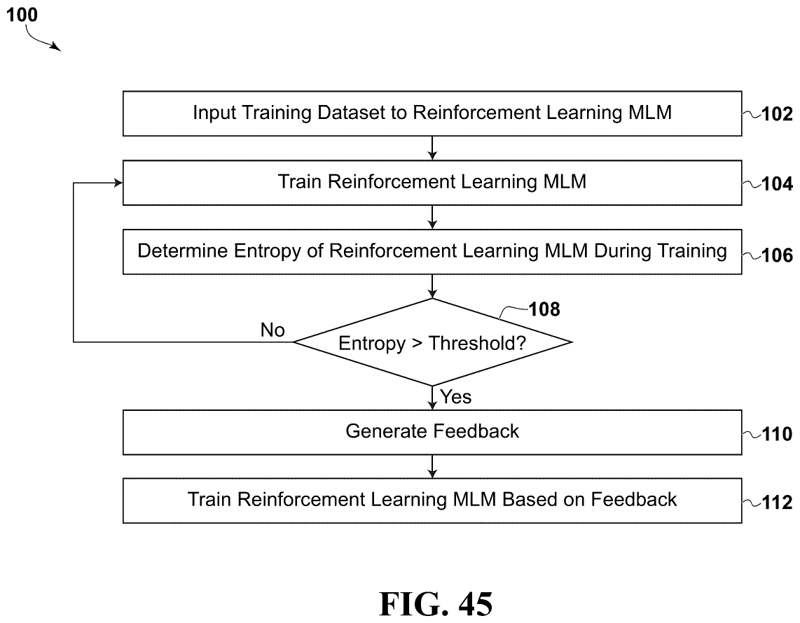

Referring to FIG. 45, and in accordance with embodiments of the disclosure, there is shown a general method 100 of using one or more computer processors to train a reinforcement learning machine learning model. Examples of the type of reinforcement learning machine learning model that may be used are provided below. According to one non-limiting example, the reinforcement learning machine learning model is a contextual bandit machine learning model.

At block 102, the one or more computer processors are used to input a training dataset to the reinforcement learning machine learning model. Examples of the training data set are provided below.

At block 104, the one or more computer processors train the reinforcement learning machine learning model based on the training dataset.

At block 106, during the training, an entropy of the reinforcement learning machine learning model is determined. The entropy may be determined according to various different methods, and/or at various different points in time during the training process, examples of which are provided below.

At block 108, the one or more computer processors compare the entropy to a threshold. If the entropy is below the threshold, training proceeds as per block 104. If, on the other hand, the entropy is determined to have exceeded the threshold, then at block 110 the one or more computer processors generate feedback. Examples of feedback that may be generated are provided below.

At block 112, the one or more computer processors continue to train the reinforcement learning machine learning model using the generated feedback.

### Contextual Bandit Formulation

We consider an online stochastic contextual bandit framework where, at each round t, the world ω generates a context-reward pair (sₜ, rₜ) sampled independently from a fixed unknown distribution [symbol] . Here sₜ∈ [symbol] = [symbol] ^{m} is an m-dimensional real valued vector and rₜ=(rₜ(1), . . . , rₜ(k))∈{0,1}^{k} is a k-dimensional vector where each element can take the value 0 or 1. The agent then chooses an action uₜ∈{1, . . . , k} according to a policy π: [symbol] [symbol] {1, . . . , k}, and the environment reveals the reward rₜ(uₜ)∈{0,1}.

The objective of the agent is to find a policy π∈Π that maximizes the expected cumulative reward given by:

$${max}_{{u}_{t} ∼ π} {\sum }_{t = 1}^{T} 𝔼 [ {r}_{t} ( {u}_{t} ) \vert {s}_{t} , {u}_{t} ] \qquad ( 1 )$$

The problem described above bears a strong resemblance to a multi-label or multiclass classification problem, where rₜ(uₜ)=1 indicates the correct label choice and 0 otherwise. However, a key distinction lies in the learner's lack of access to the correct label or label set for each observation. Instead, the learner only discerns whether the chosen label for an observation is correct or incorrect. As a result, standard binary or multi-class classification datasets can often be repurposed for the contextual bandit setting, with the features serving as the contexts. In this framework, each instance in the dataset, along with its features, represents a distinct situation where the learning agent must select an action (analogous to predicting a class label). The outcome of the chosen action, when compared to the actual label, determines the immediate reward, guiding the learning process within the contextual bandit framework.

### Incorporating Human Feedback

Feedback in contextual bandits is usually provided in the form of a reward signal predetermined by the designer. For example, consider a binary classification task posed as a contextual bandit problem where the objective is to maximize the average classification accuracy. The reward function in this case can be rₜ(uₜ)∈{1,0} for correct and incorrect classifications, respectively. Alternatively, when the objective is to reduce the number of false positives in a task (e.g., in a recommendation task), this reward function can be appropriately calibrated so that the learner is penalized for making a recommendation that is not relevant. This feedback, based on a predesigned reward function, is defined as implicit feedback. This feedback can comprise certain user-engagement metrices in a recommendation system, such as click-through rates, whether purchases were made after a recommendation, etc.

In contrast, according to embodiments of the disclosure, the feedback provided by a human expert is defined as explicit feedback which can directly influence the action that a contextual bandit learner will take. Human experts typically bring valuable insights stemming from their experience, specialized knowledge, and familiarity within the domain. However, the quality of such explicit feedback may vary based on the different levels of expertise of different individuals.

According to some embodiments of the disclosure, there are two ways in which human experts can provide feedback to the contextual bandit learner: i) action recommendation through direct supervision; and ii) reward-based feedback. Each of these different types of feedback is described below.

According to embodiments of the disclosure, human feedback may be approximated using a suitably trained machine learning model. For example, a trained neural network comprising a multi-layer perceptron (comprising multiple layers of neurons in a fully-connected setup) may be used to generate outputs that may be used as proxies for human feedback. Such a model may be trained using gradient descent using the Adam optimizer as an example. The corresponding learning rate may be set by hyper-parameter optimization on a held-out validation set.

### Action Recommendation Via Direct Supervision

In this form of feedback, the human expert explicitly instructs what actions to take for a given context. It is assumed that, when the human recommends actions through direct supervision, the algorithm always follows these recommendations regardless of any previous evaluations of the quality of this feedback. Let ûₜ be the recommended action by the human expert ε. The final reward

$${r}_{t}^{f}$$

received by the reamer is given by:

$${\hat{u}}_{t} = ε ( {s}_{t} )$$

$${r}_{t}^{f} = {r}_{t} ( {\hat{u}}_{t} ) + {r}_{q}$$

where r_{q} is a penalty received for querying the expert.

According to some embodiments, action recommendation may involve restricting the number of actions that may be selected by the contextual bandit to a number q of actions, wherein q is less than or equal to the number of actions that may be selected divided by 2.

### Reward Manipulation

According to this form of feedback, the human expert provides an additional reward penalty to the learner whenever the learner chooses an action that is not the recommended action according to the expert. Let rₚ be a fixed reward penalty provided by the expert when the learner chooses a non-recommended action according to the expert. Let uₜ be the action chosen by the learner at round t and let ûₜ denote the recommended action by the human expert. The final reward

$${r}_{t}^{f}$$

received by the learner as a result of such feedback is given by:

$${r}_{t}^{f} = \{ \begin{matrix}{r}_{t} ( {u}_{t} ) + {r}_{p} + {r}_{q} & if {u}_{t} \neq {\hat{u}}_{t} \\ {r}_{l} ( {u}_{l} ) + {r}_{q} & otherwise\end{matrix}$$

where r_{q} is the penalty received for querying the expert.

### When to Seek Human Feedback?

An important question that naturally arises when integrating human feedback into the contextual bandit algorithm is that of when the algorithm should actively seek out such feedback. According to embodiments of the disclosure, the learner seeks expert feedback based on model uncertainty. The model computes the entropy of the policy at each round t, which quantifies the degree of unpredictability in the policy's decision-making process, using the following expression:

$$H ( π ) = - {\sum }_{{u}_{t}} π ( {u}_{t} \vert {s}_{t} ) log ( π ( {u}_{t} \vert {s}_{t} ) ) \qquad ( 2 )$$

where H(π) denotes the entropy of policy π. The model then requests human feedback when the entropy exceeds a predefined threshold λ. Appropriate choice of λ will depend on the problem domain and is obtained using hyperparameter search.

According to some embodiments, determining the entropy comprises: determining a number of actions that may be selected by the reinforcement learning machine learning model and respective probabilities of the reinforcement learning machine learning model selecting each action; and calculating H(p)=Σᵢpᵢ log₂ pᵢ, wherein H is the entropy and pᵢ is the probability of selecting the i^{th} action.

### Quality of Experts

The quality of the expert feedback that is received will have an effect on the learner's performance. The quality of feedback is defined in this case as the accuracy with which the expert provides a correct recommendation. We first show how the performance of the contextual bandit learner, measured by the expected cumulative reward, varies for different expert levels (i.e., for different levels of accuracy). Let [symbol] ∈{0.1,0.2, . . . ,1} be the probability of providing a correct recommendation associated with a particular level of expert. During training, the algorithm seeks expert feedback when H(π)≥1. For action recommendation via direct supervision, the expert provides the correct action with probability [symbol] and provides a randomized action with probability 1− [symbol] . For reward manipulation feedback, the expert wrongly penalizes the learner with a probability of 1− [symbol] . In the experiments shown herein, the expert feedback is modeled by revealing the correct actions associated with a context for a given value of [symbol] .

### Algorithms and Environments Considered

In what follows, we experiment over a set of environments and contextual bandit agents. The following policy-based learners were considered for contextual bandit agents: i) Proximal Policy Optimization (PPO) (John Schulman, Filip Wolski, Prafulla Dhariwal, Alec Radford, and Oleg Klimov. Proximal policy optimization algorithms. arXiv preprint arXiv: 1707.06347, 2017); ii) PPO with Long Short-Term Memory (LSTM), iii) Reinforce (Ronald J Williams. Simple statistical gradient-following algorithms for connectionist reinforcement learning. Machine learning, 8(3-4): 229-256, 1992); iv) Actor Critic (Tuomas Haarnoja, Aurick Zhou, Pieter Abbeel, and Sergey Levine. Soft actor-critic: Off-policy maximum entropy deep reinforcement learning with a stochastic actor. In Jennifer Dy and Andreas Krause, editors, Proceedings of the 35th International Conference on Machine Learning, volume 80 of Proceedings of Machine Learning Research, pages 1861-1870. PMLR, 10-15 Jul. 2018); v) ACER (Ziyu Wang, Victor Bapst, Nicolas Heess, Volodymyr Mnih, Remi Munos, Koray Kavukcuoglu, and Nando de Freitas. Sample efficient actor-critic with experience replay, 2017); and vi) Linear Upper Confidence Bound (UCB) (Lihong Li, Wei Chu, John Langford, and Robert E Schapire. A contextual-bandit approach to personalized news article recommendation. In Proceedings of the 19th international conference on World wide web, pages 661-670, 2010), all of which are hereby incorporated by reference in their entireties. The first five algorithms are policy-based reinforcement learning algorithms. In the case of the problem posed above, since we are in a contextual bandit setup, the discount factor for the first five algorithms is set to γ=1 so that the learner only cares about maximizing the immediate reward. Linear UCB extends the UCB algorithm (Peter Auer. Using confidence bounds for exploitation-exploration trade-offs. Journal of Machine Learning Research, 3(Nov): 397-422, 2002), incorporated herein by reference in its entirety, to handle situations where each action's expected reward depends linearly on the context or features associated with that action. For Linear UCB, the prediction score of the model is converted to obtain a measure of model uncertainty. For other models, the model uncertainty can be directly obtained from the parametrized model. Policy evaluation was then performed with independent Monte-Carlo runs for all the models. During policy evaluation, the mean accuracy of the predictive model (i.e., the average number of correct classification/recommendations made) was recorded, and these values are then reported in the experimental results.

The following multi-label datasets were used, taken from the extreme classification repository (K. Bhatia, K. Dahiya, H. Jain, P. Kar, A. Mittal, Y. Prabhu, and M. Varma. The extreme classification repository: Multi-label datasets and code, 2016) and Yahoo Front Page Today Module User Click Log Dataset (Yahoo Academic Relations. R6a—yahoo! front page today module user click log dataset, 2012). These datasets were used as they are large, complex, and diverse, meaning that they provide a robust setting on which to evaluate contextual bandits with human feedback.

### Implementation Details and Hyperparameters

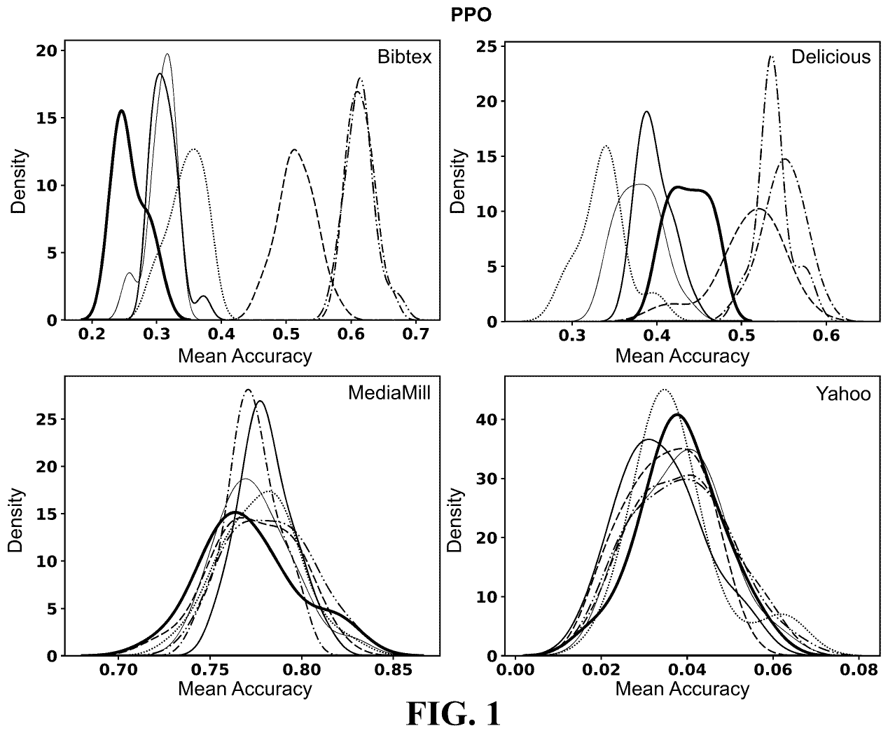

A range of entropy thresholds were used for different datasets, as can be seen below in FIG. 1. These entropy thresholds were treated as hyperparameters that control how frequenty the algorithm seeks to incorporate human feedback.

TABLE 1
Entropy thresholds for different environments A

| Dataset | λ values |
|---|---|
| Bibtex | 2.5, 3.5, 5.0, 6.5, 9.0 |
| Media Mill | 1.5, 2.5, 3.0, 4.5, 7.0 |
| Delicious | 1.5, 2.5, 4.5, 6.5, 9.0 |
| Yahoo | 1.5, 2.5, 4.5, 7.0, 9.0 |

For each dataset, the optimal value of the entropy thresholds was selected and the mean accuracy for both Action Recommendation (AR) and Reward Modification (RM) across four random seeds is then reported. The code base for the policy-based reinforcement learning algortihms is based on PyTorch and adapted from n seungeunrho. MinimalRL. https://github.com/username/repository, 2019, herein incorporated by reference in its entirety. For Linear UCB, the implementation is based on David Cortes, Adapting multi-armed bandits policies to contextual bandits scenarios, 2019, arXiv: 1811.04383, herein incorporated by reference in its entirety. For the policy-based models, the following hyper parameters were used:

TABLE 2
Hyperparameters for policy-based algorithms

| | | | Advantage | | |
|---|---|---|---|---|---|
| | Training | Learning | Function | Clipping | |
| Algorithms | Epochs | Rate | Discount | Parameter | Batch Size |
| PPO | 5000 | 0.005 | 0.1 | 0.1 | 32 |
| PPO-LSTM | 5000 | 0.001 | 0.95 | 0.1 | 32 |
| Reinforce | 5000 | 0.0002 | — | — | — |
| Actor Critic | 5000 | 0.002 | — | — | 32 |
| ACER | 5000 | 0.0002 | — | — | 32 |

### Standard Approaches Fail to Benefit From Improved Level of Human Feedback

We considered a range of learners with three levels of human feedback. Taking as an illustration the case of the ACER learner, Table 2 showcases two interesting findings. First, the different learners benefit more from being provided with human feedback than being denied human feedback, as expected. Secondly, the quality of human feedback is not correlated with the learner's final performance. In other words, more information does not necessarily entail stronger generalization.

As can also be seen, frequent acquisition of human feedback, either at every epoch or during each learning step, tends to diminish performance, particularly when employing action restriction as the feedback type. This phenomenon stems from the constraint imposed by obtaining feedback at each iteration, which limits the variety of actions available to agents, thereby hindering effective exploration. Subsequently, entropy-based thresholds that trigger requests for human feedback are explored.

### Introducing Entropy-Based Thresholds Improve the Learner's Performance Consistently When Compared to Baselines

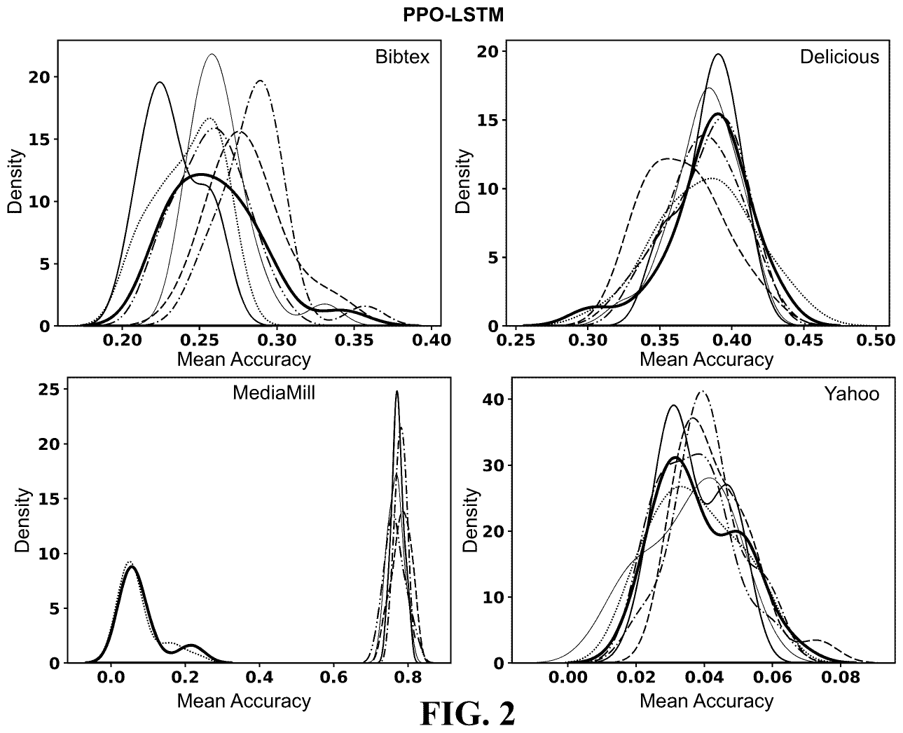

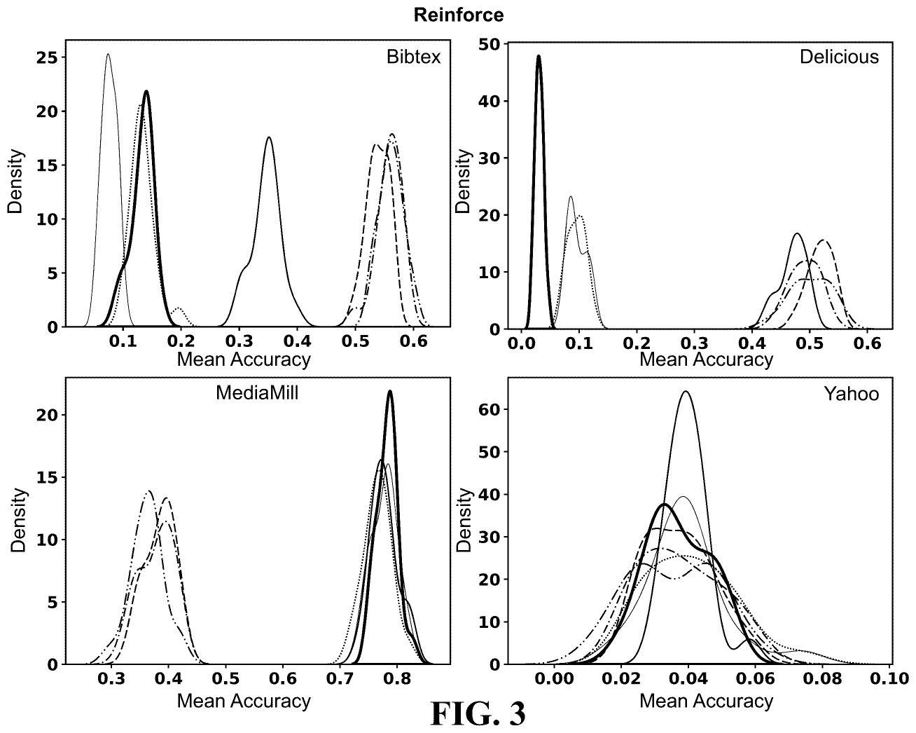

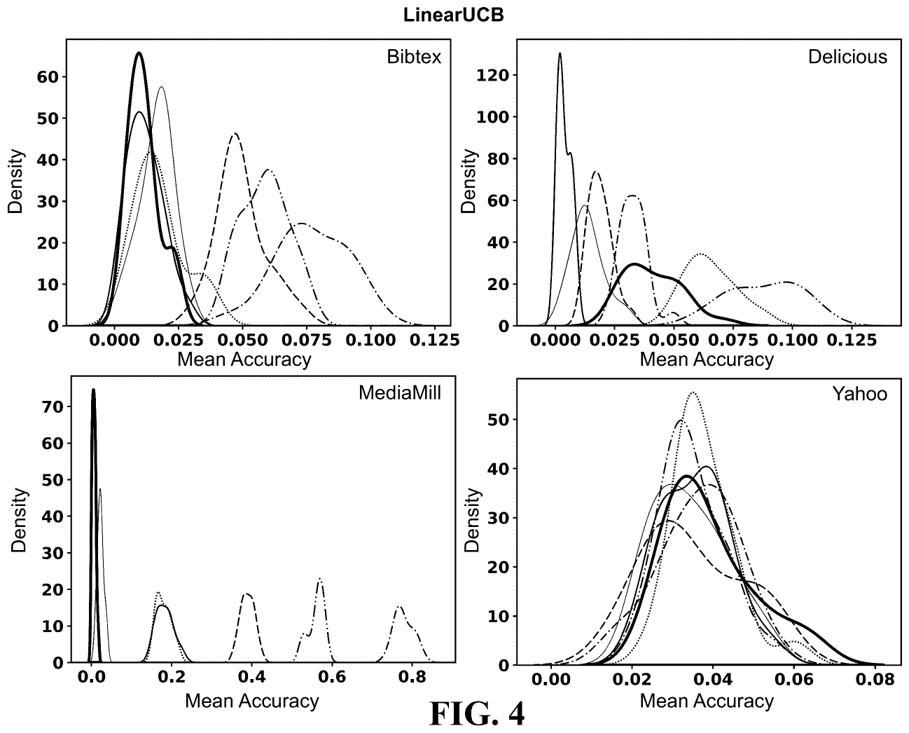

As can be seen in Table 3 (below), the advantages of incorporating entropy-based human feedback are evident. Table 3 presents the results for both action restriction feedback and reward penalty feedback, applied at optimal entropy thresholds. The determination of these optimal thresholds, as mentioned above, is based on empirical evaluation. Table 3 clearly indicates that, for algorithms such as PPO, PPO-LSTM, Reinforce, and Linear UCB, the integration of either action restriction or reward-based feedback consistently enhances the model's performance. This improvement is further illustrated in the Kernel Density Estimation (KDE) plots shown in FIGS. 1-4. These plots reveal a notable shift in performance distribution post-convergence. In particular, the AR and RM schemes that were implemented can be seen to have a strong impact on the distribution of the model's performance. More particularly, the implementation of action-based restriction as a form of human feedback results in a significant increase in the accuracy distribution for most algorithms and environments. An exception is observed in the Yahoo dataset, where PPO-LSTM and Reinforce display higher peak values in the distribution compared to their respective baselines. Furthermore, while the relative performance of the models based on different expert levels and different feedback types varies across settings, higher-level experts consistently outperform lower-level experts.

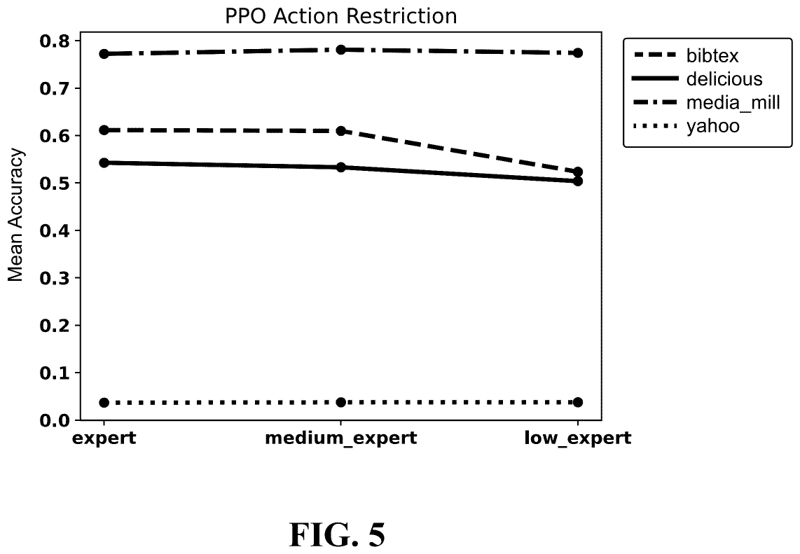

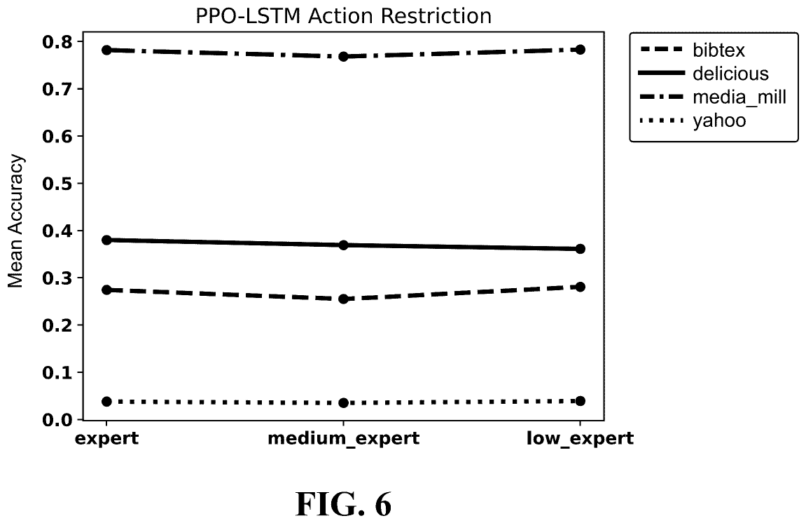

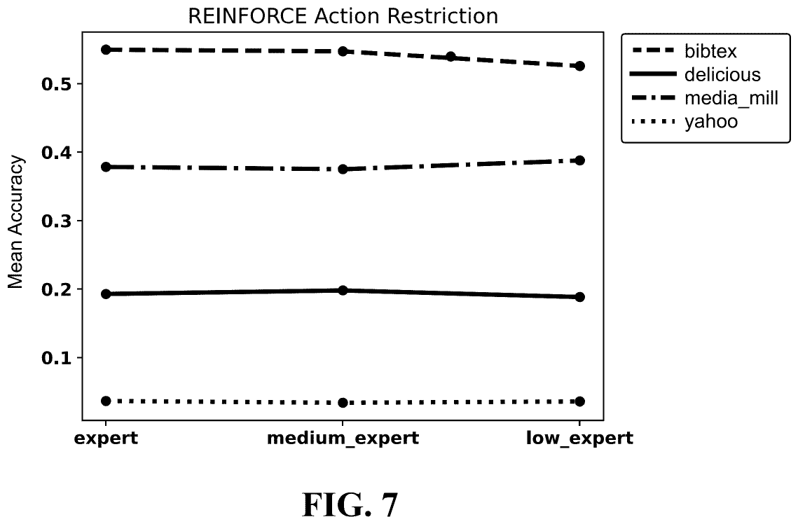

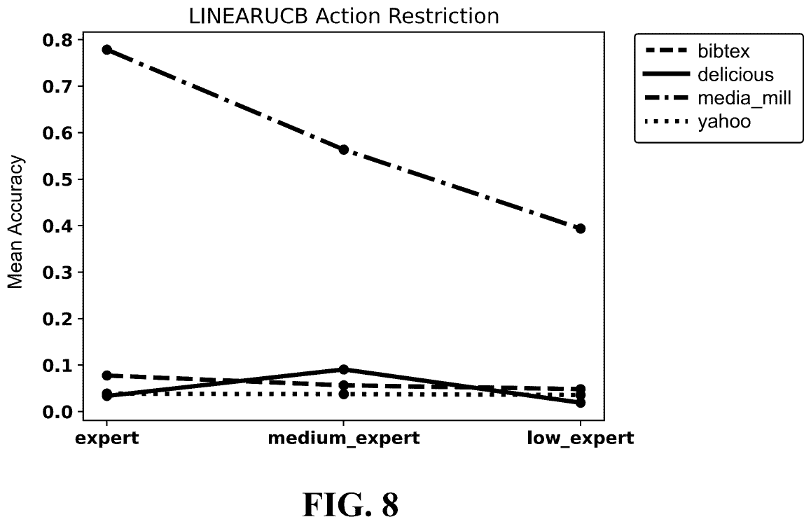

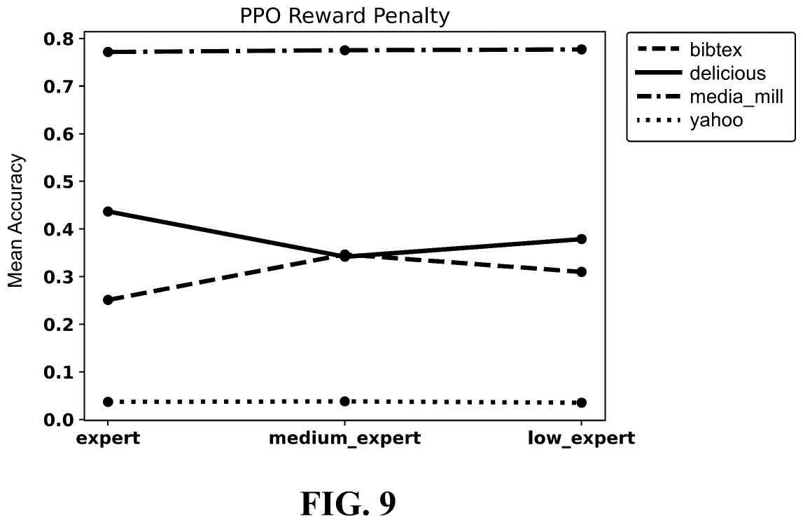

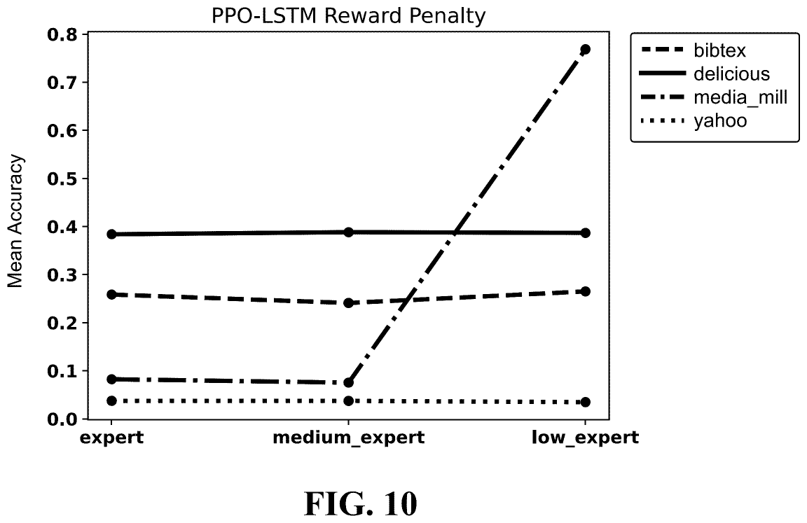

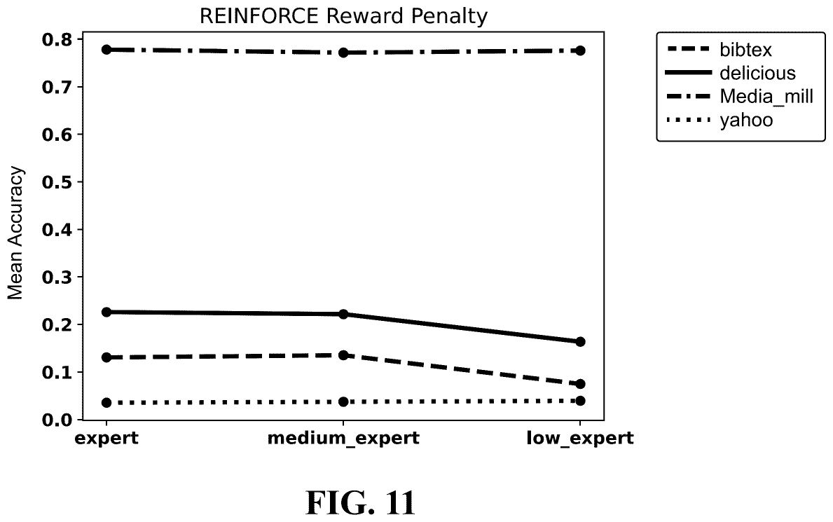

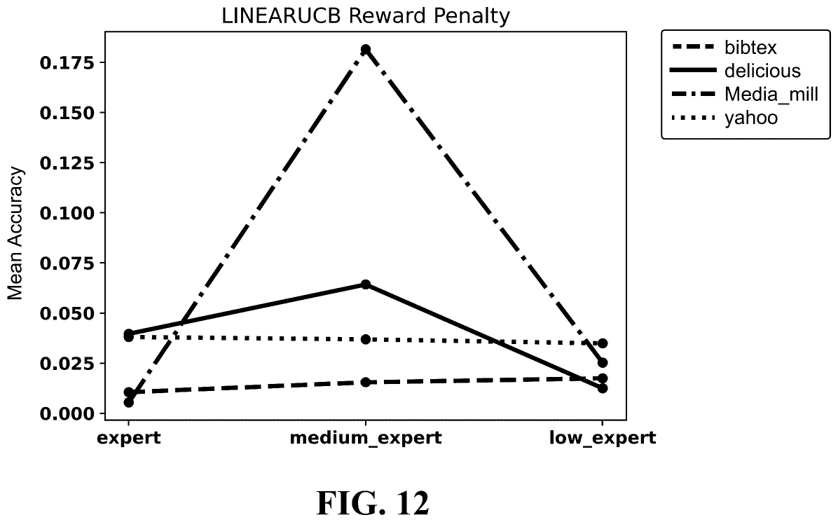

FIGS. 5-12 examine the impact of varying levels of expertise on model performance. These plots illustrate the final performance variations across different algorithms and when subjected to varying expert levels for both action restriction and reward penalty feedback types. The analysis indicates that, with action restriction (AR) feedback, a reduction in the level of expert feedback generally (but not always) leads to decreased model accuracy across most datasets. In contrast, with reward penalty (RP) feedback, this trend is not consistently observed. For instance, in certain cases such as Delicious:RP:PPO and MediaMill:RP:PPO-LSTM, a decrease in the accuracy of expert level feedback somewhat surprisingly corresponds to an improvement in performance.

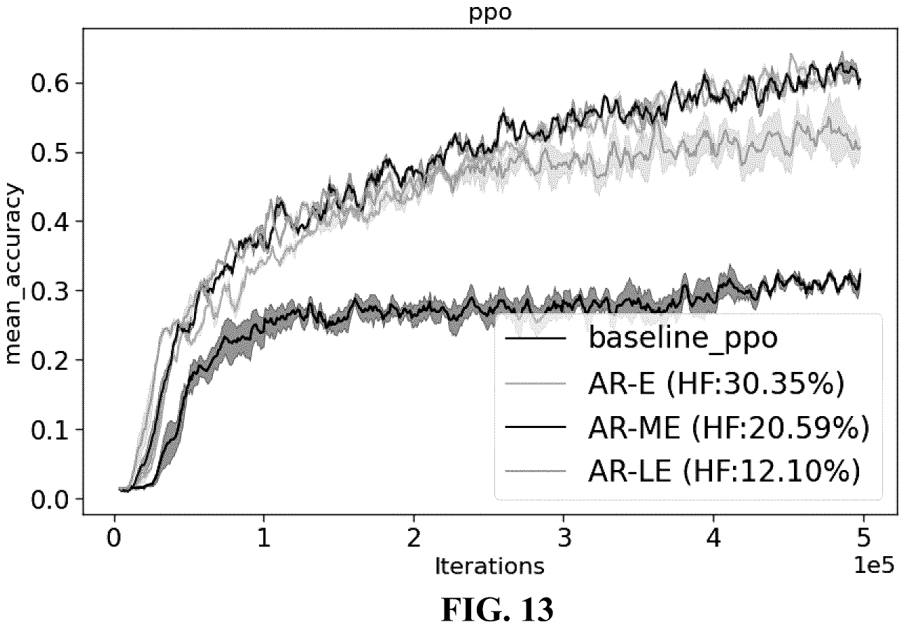

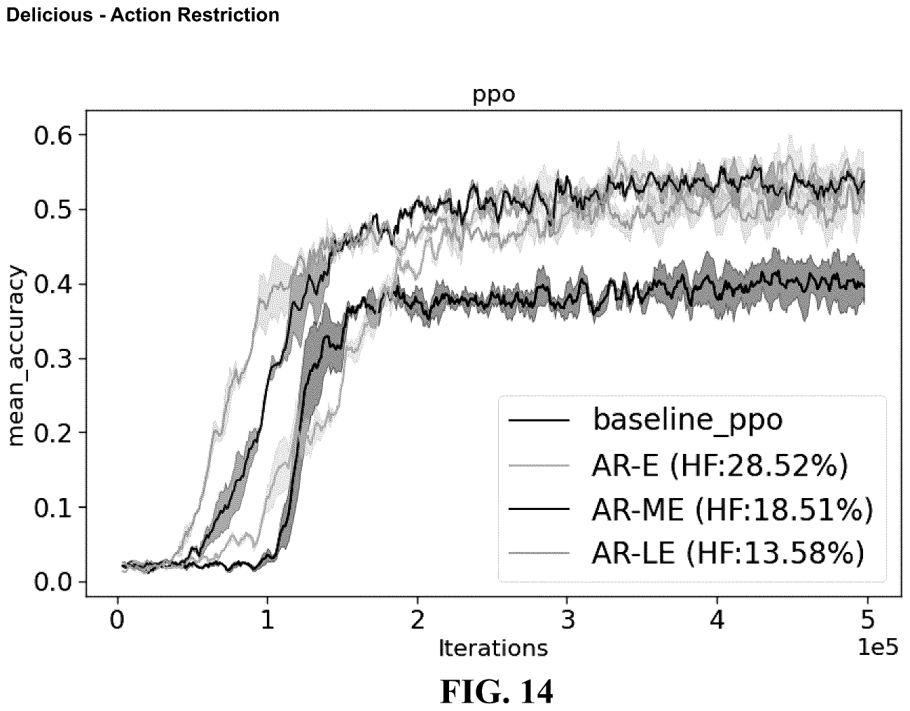

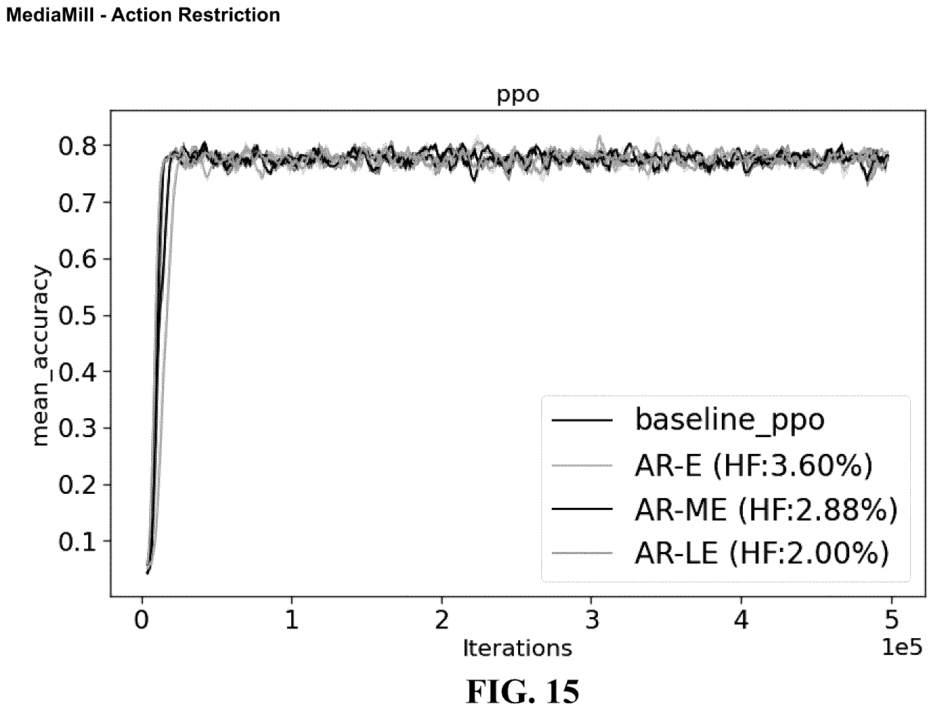

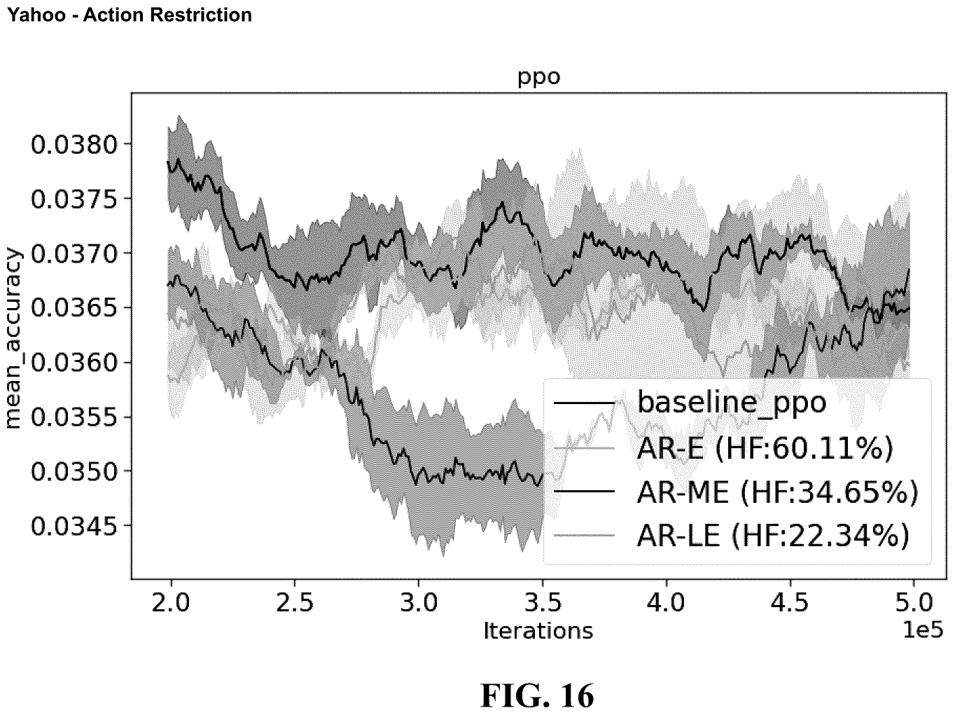

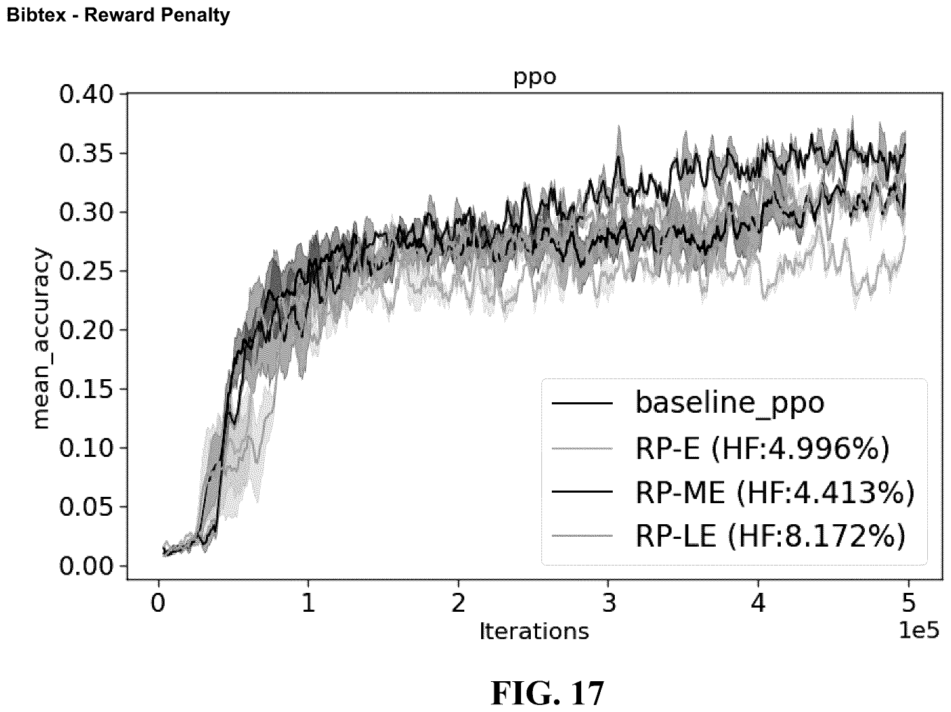

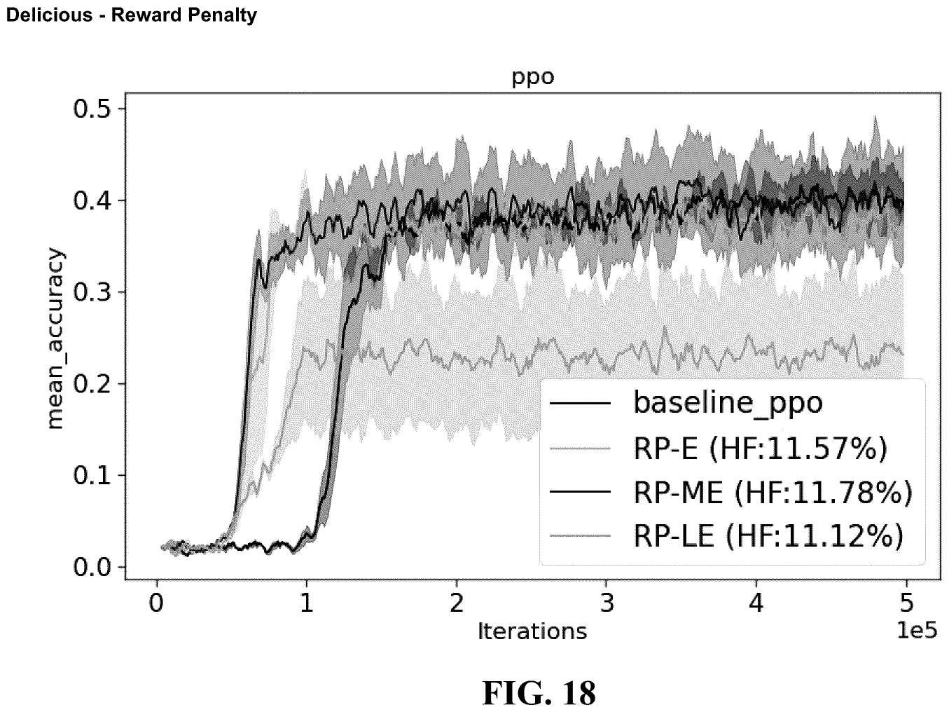

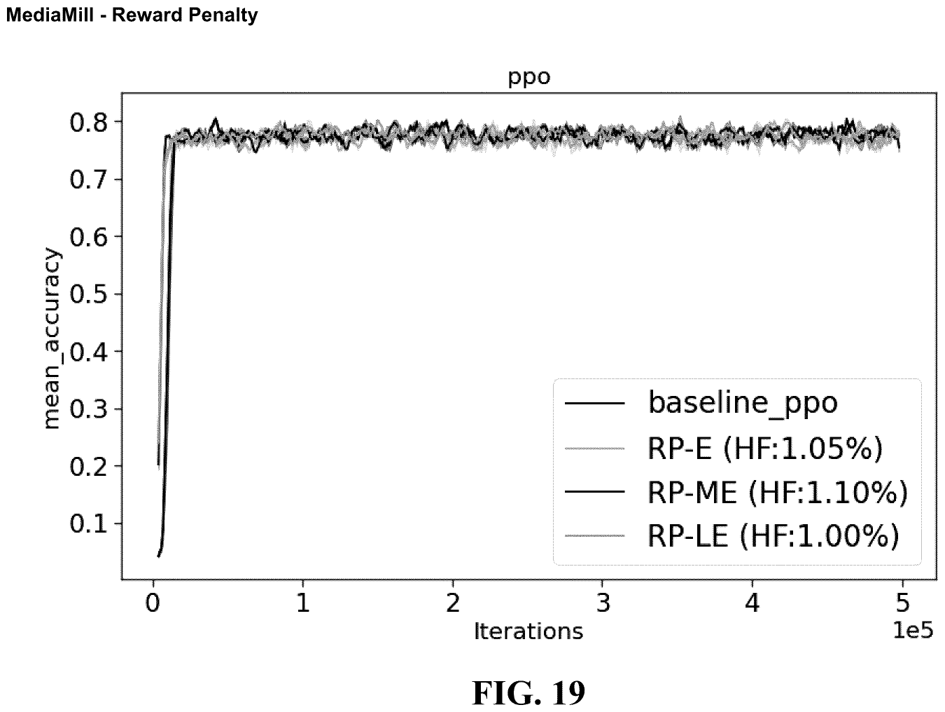

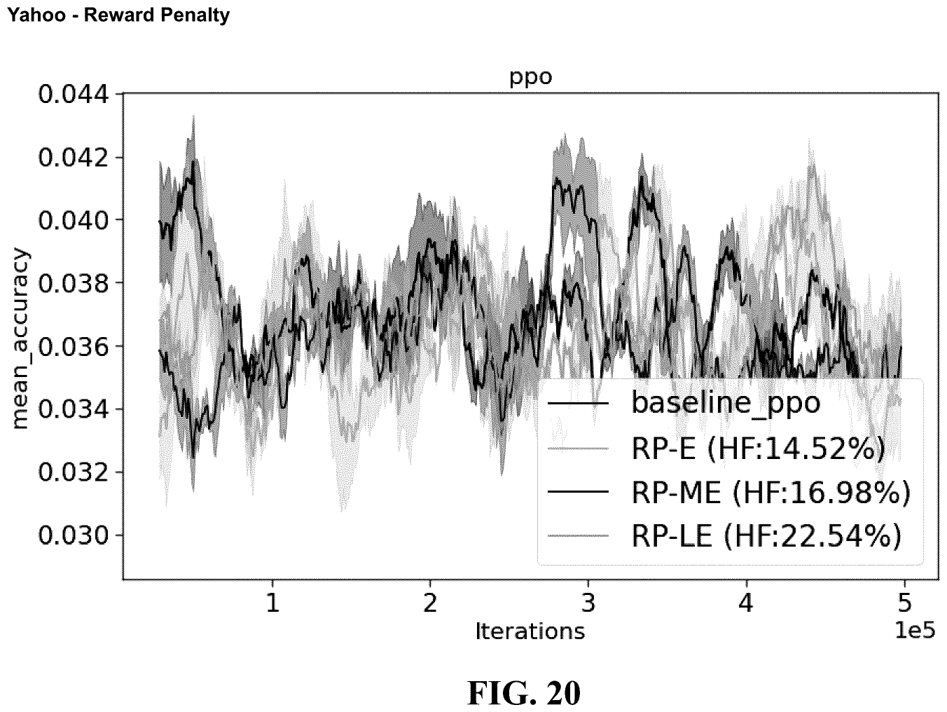

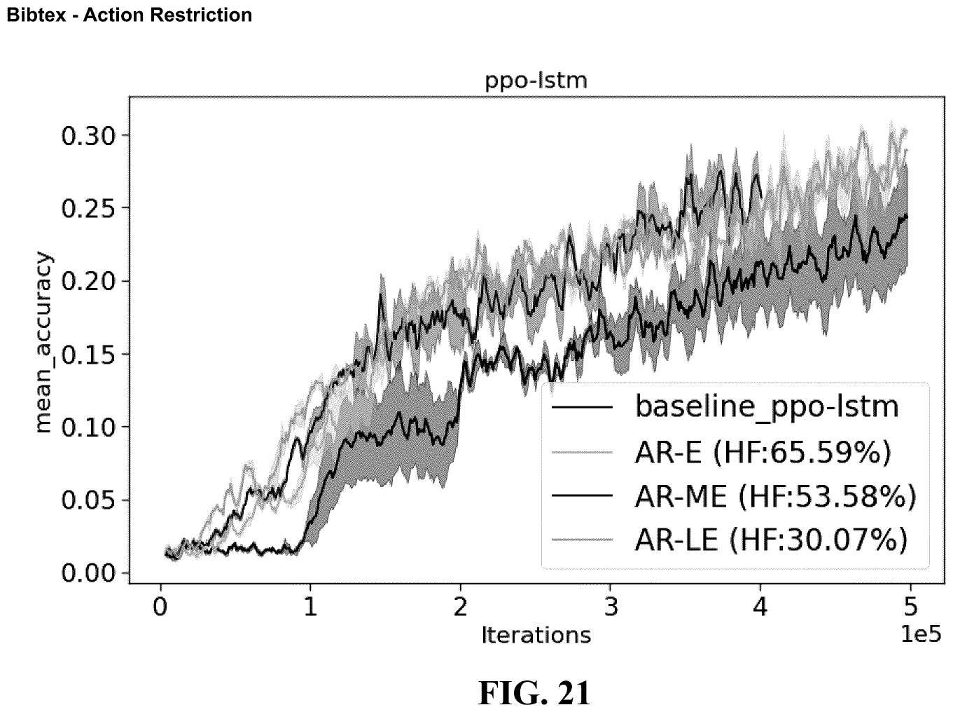

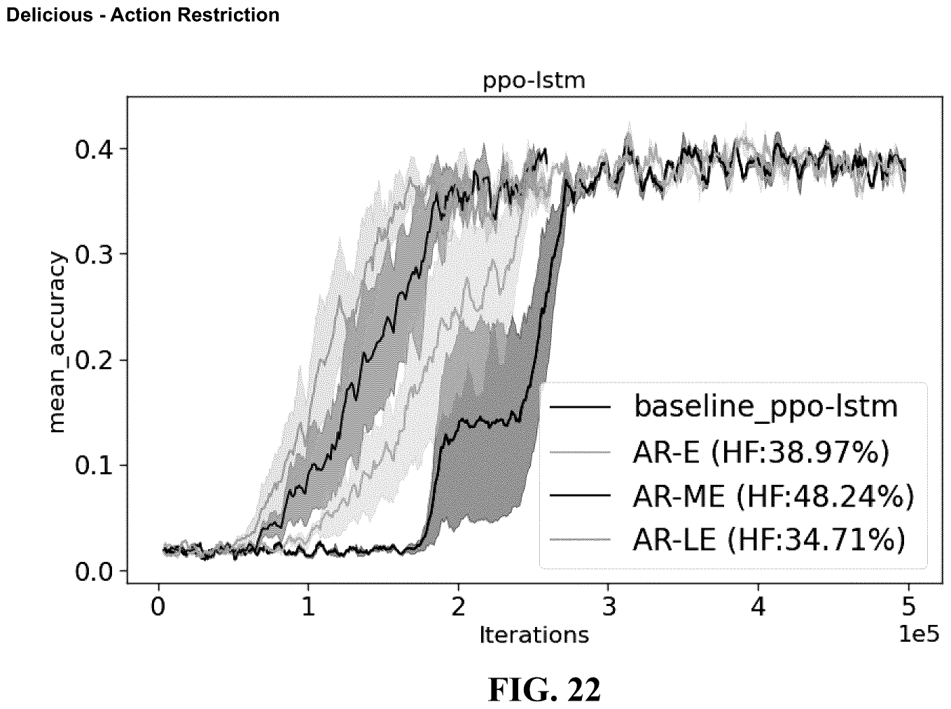

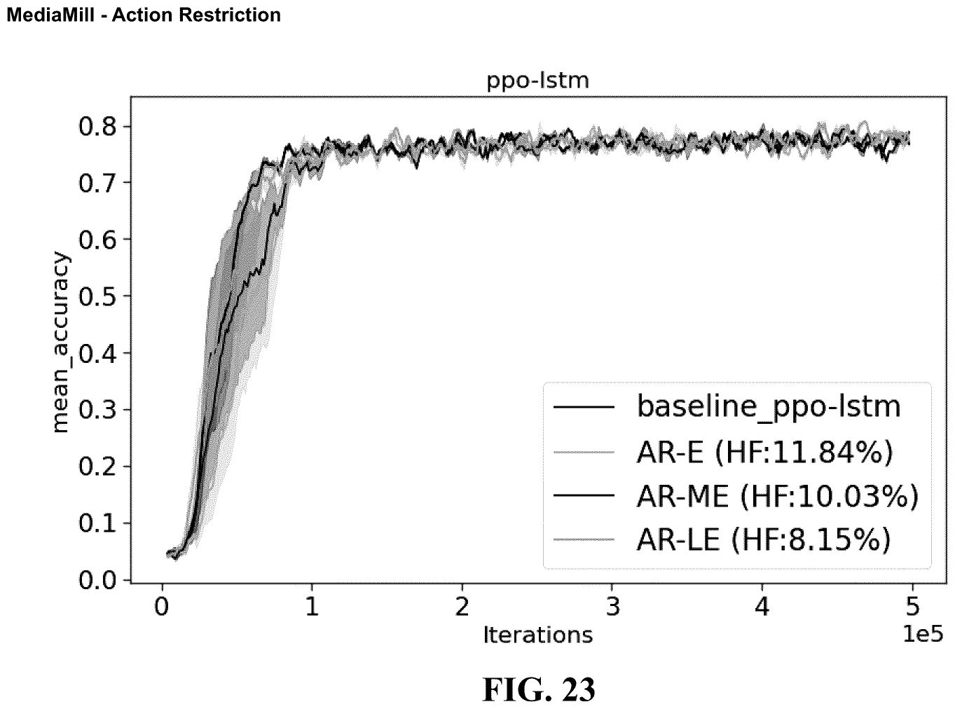

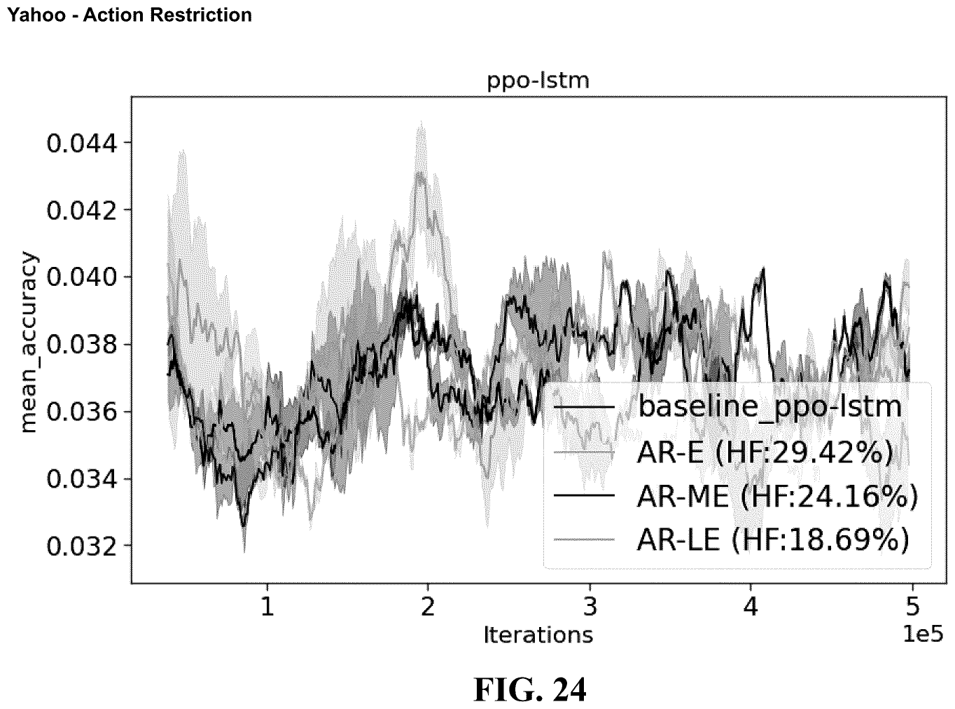

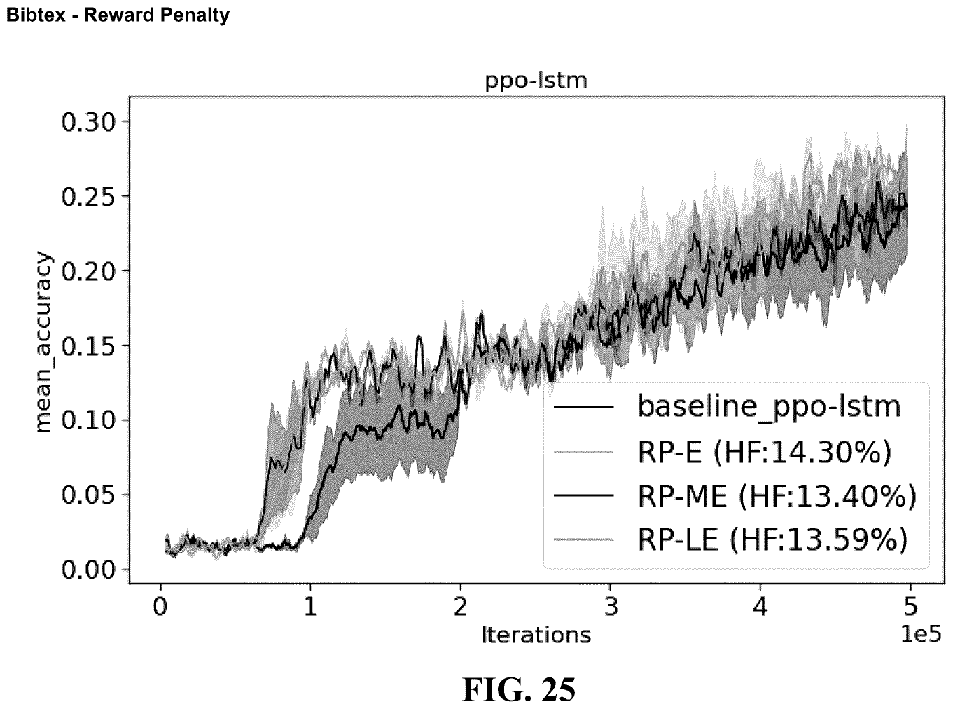

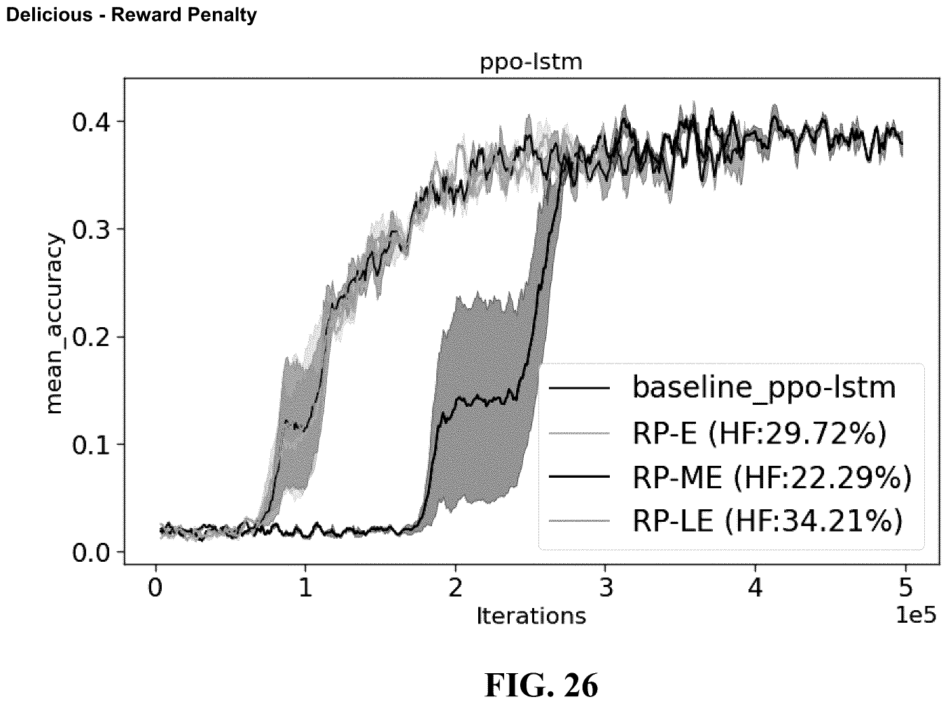

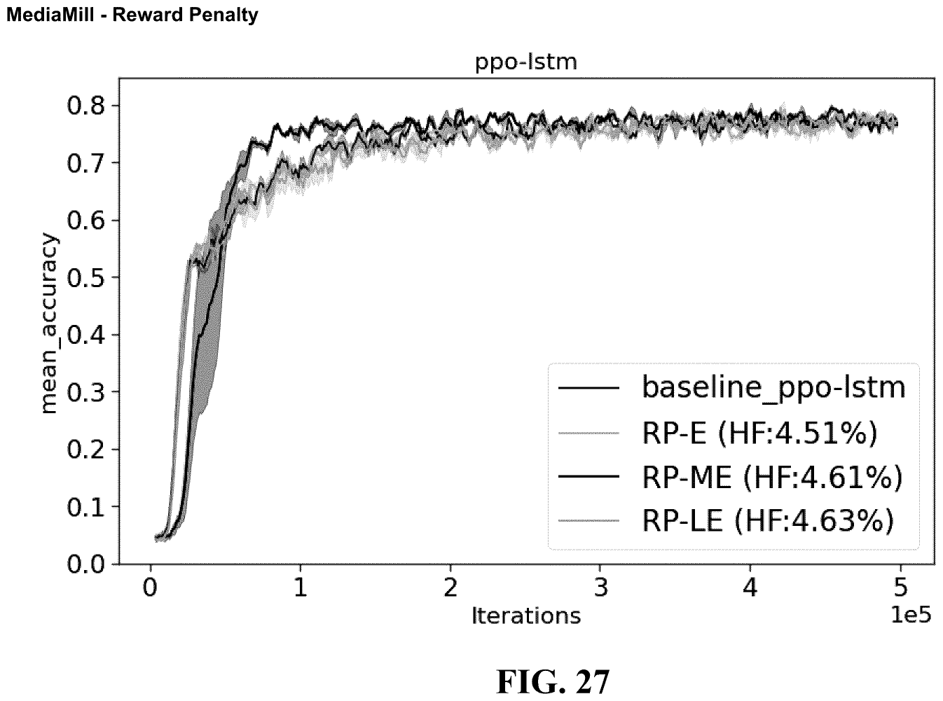

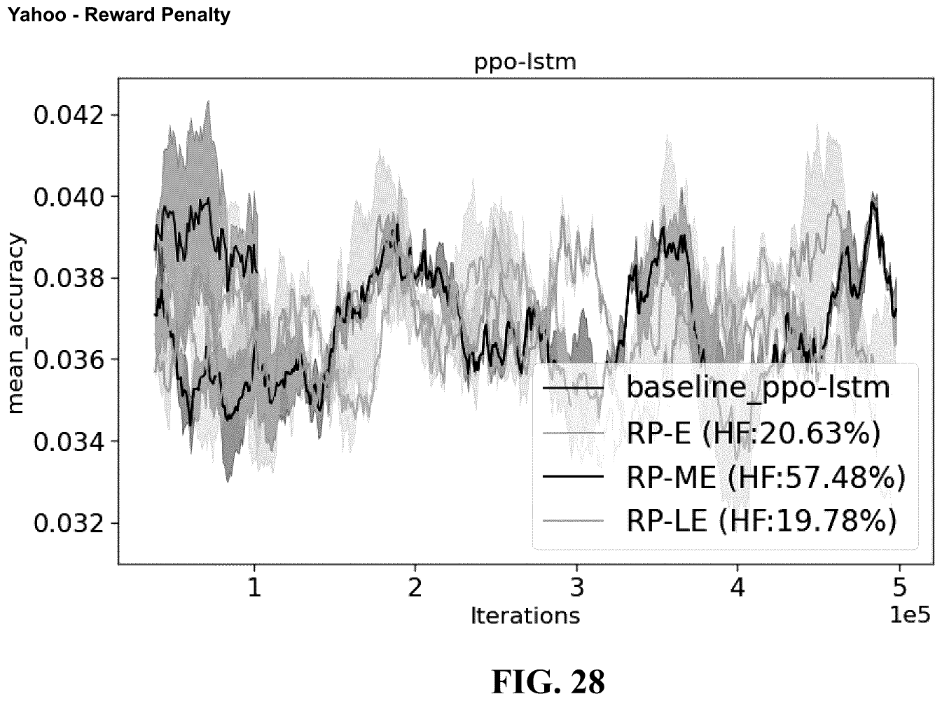

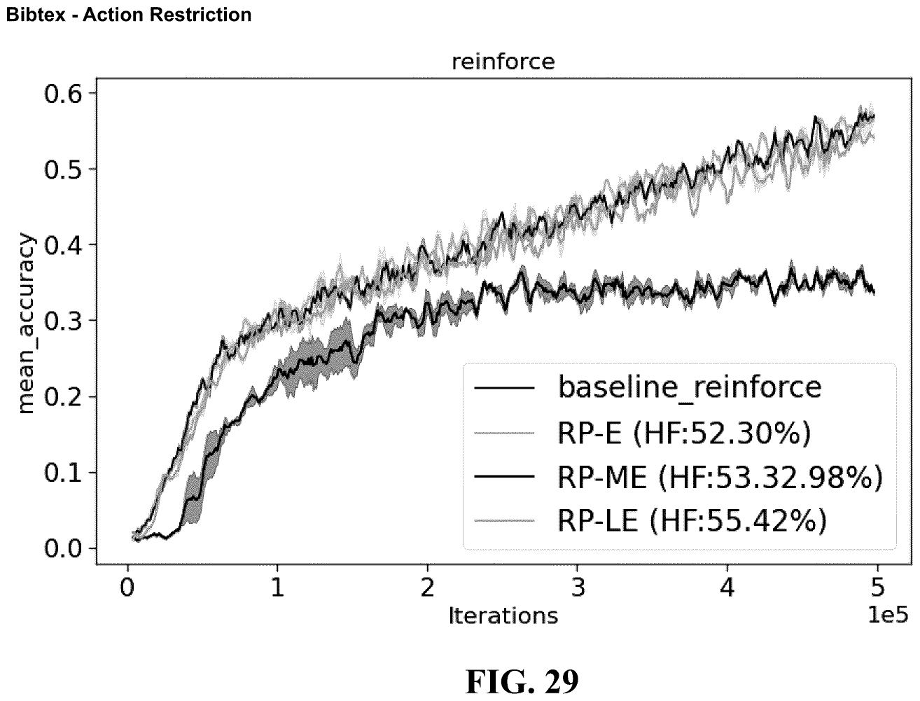

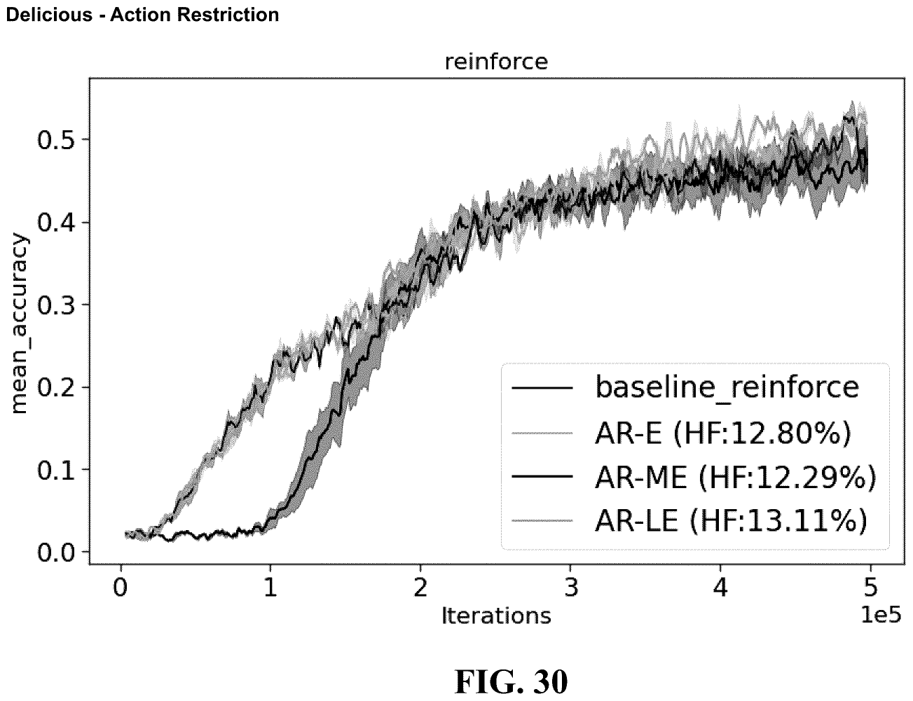

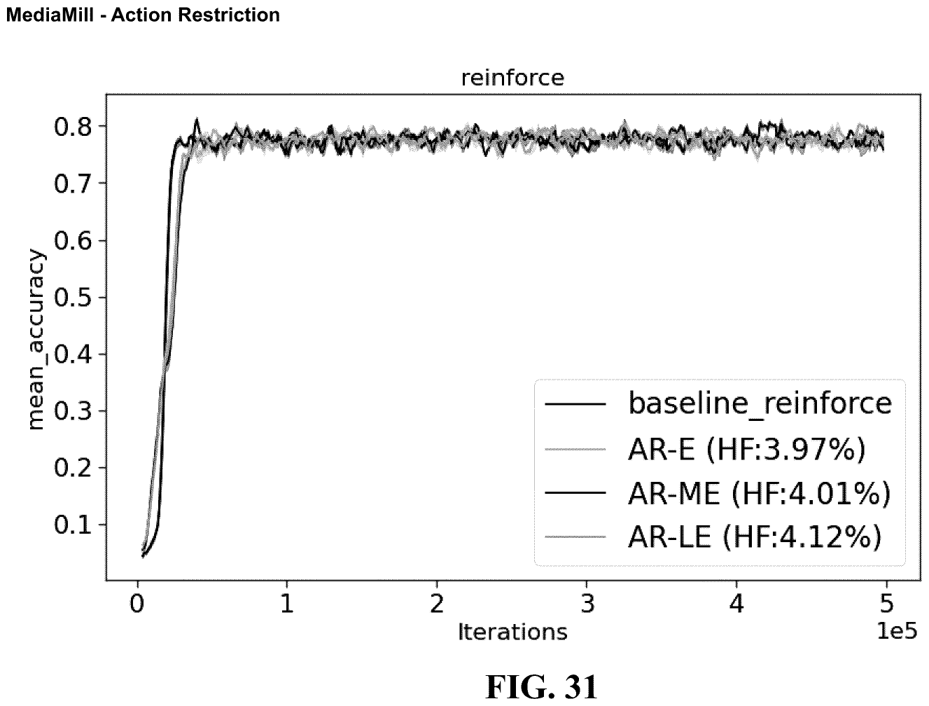

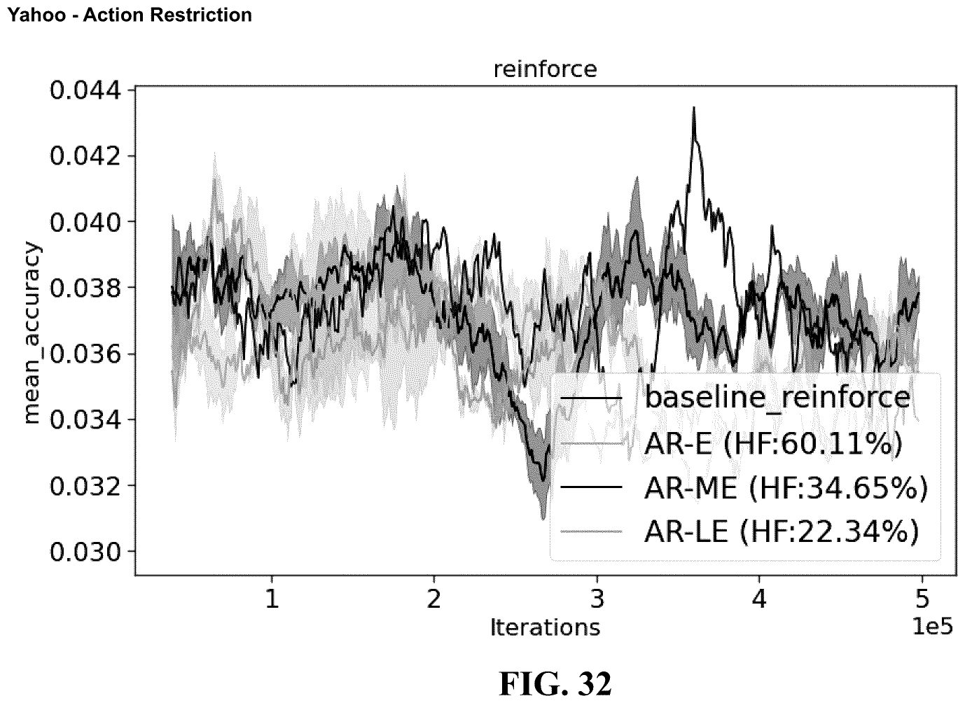

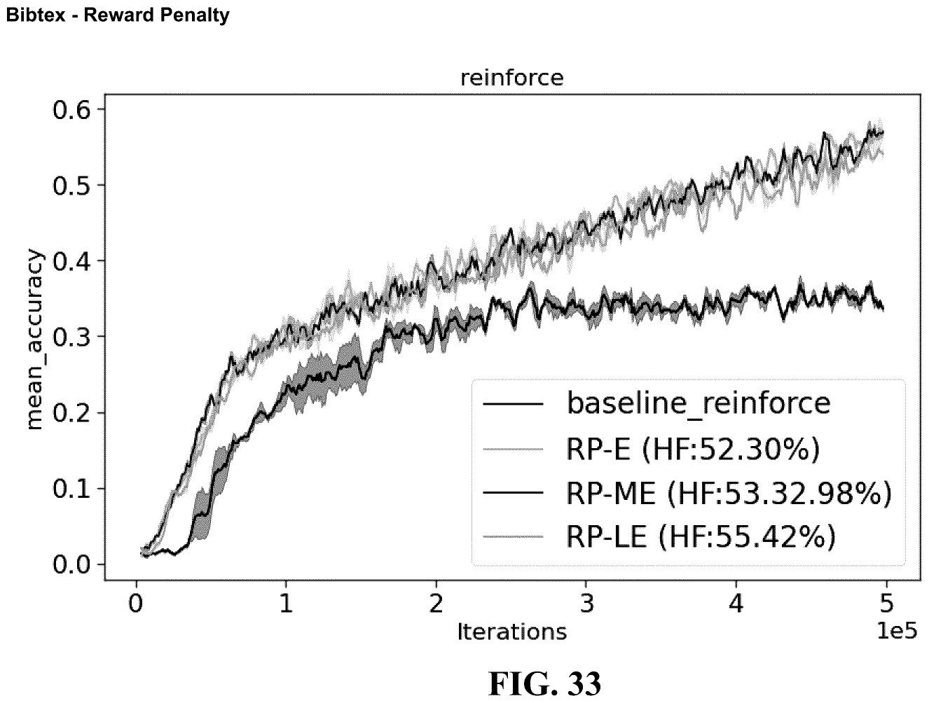

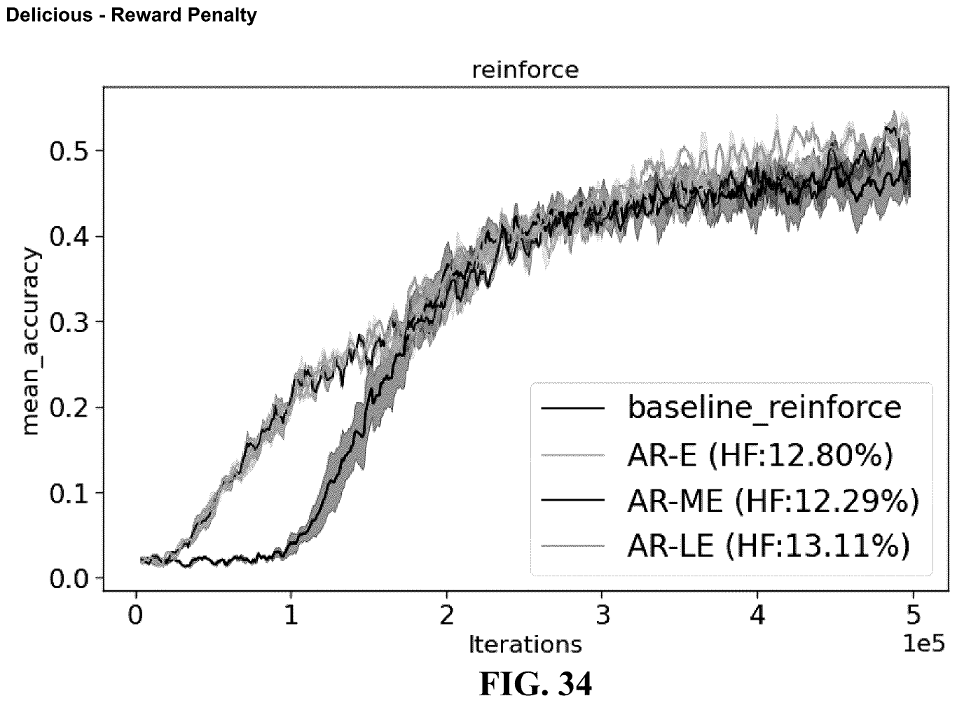

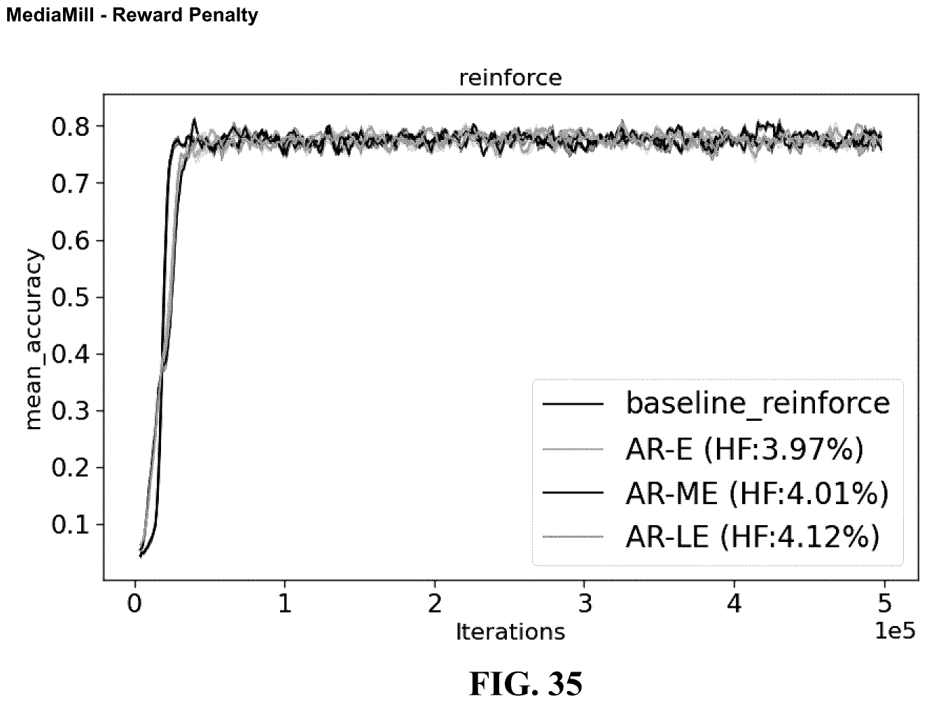

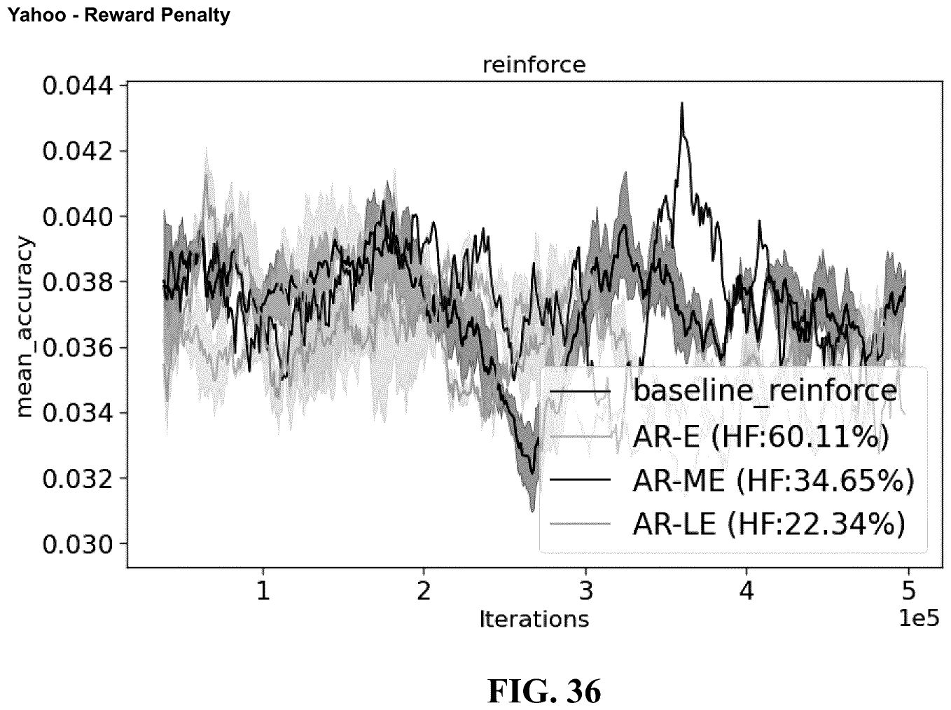

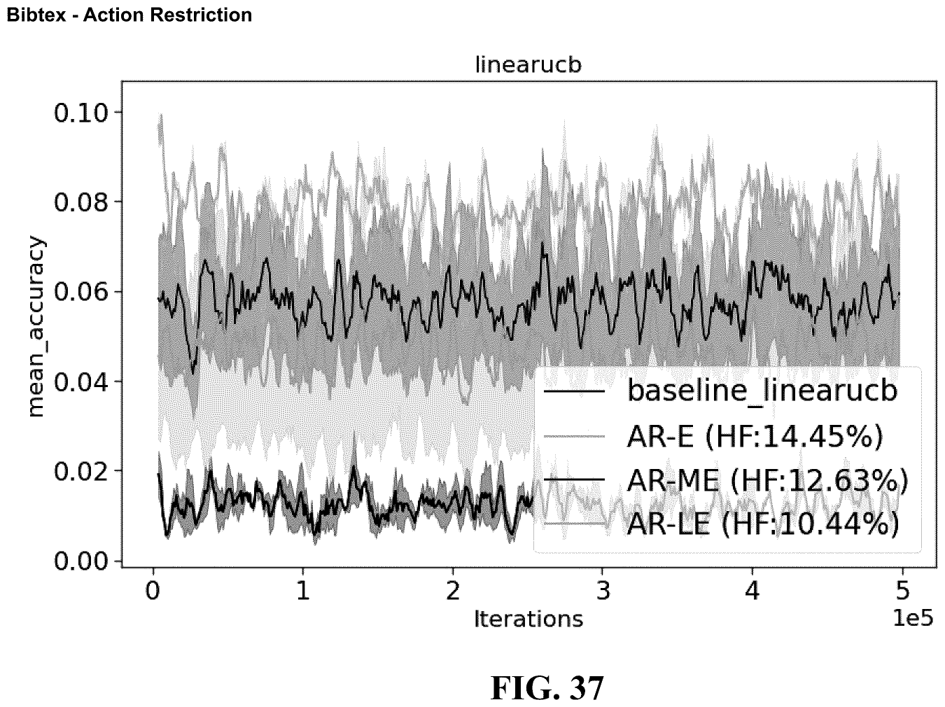

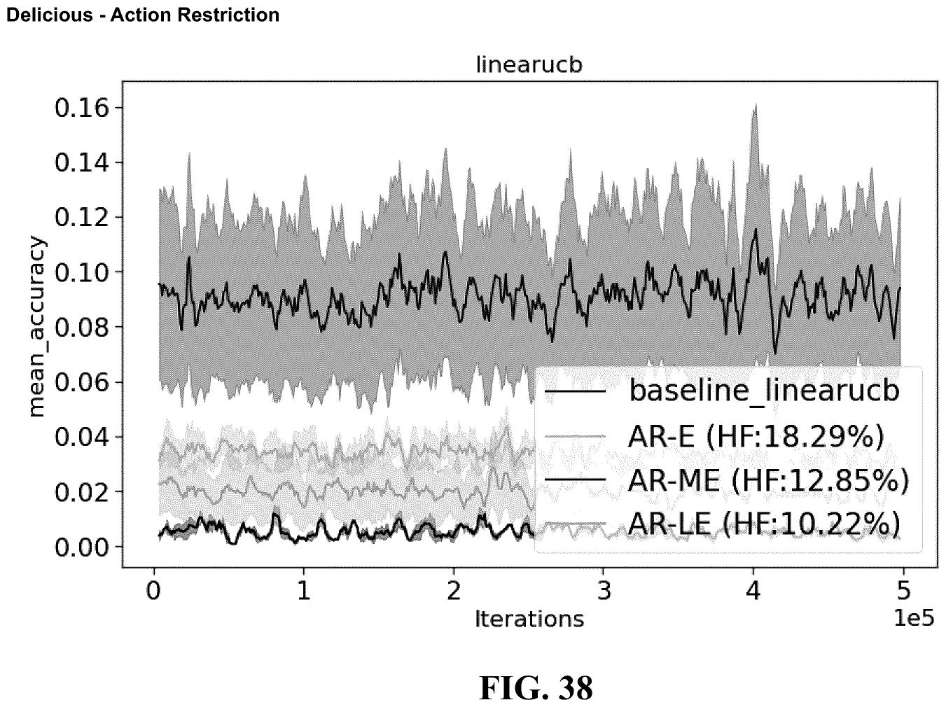

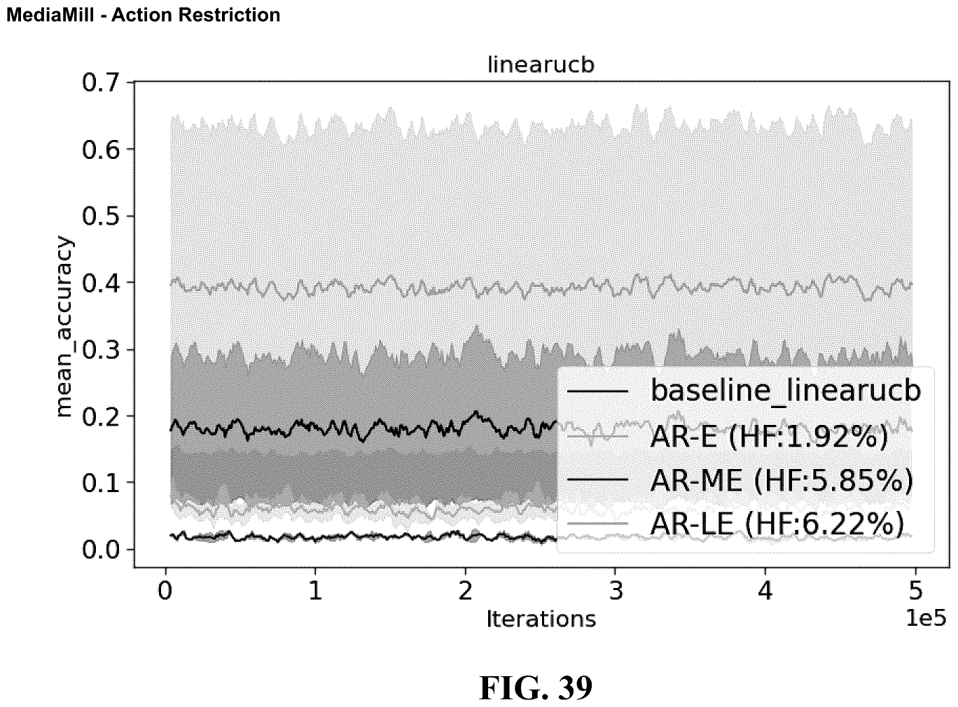

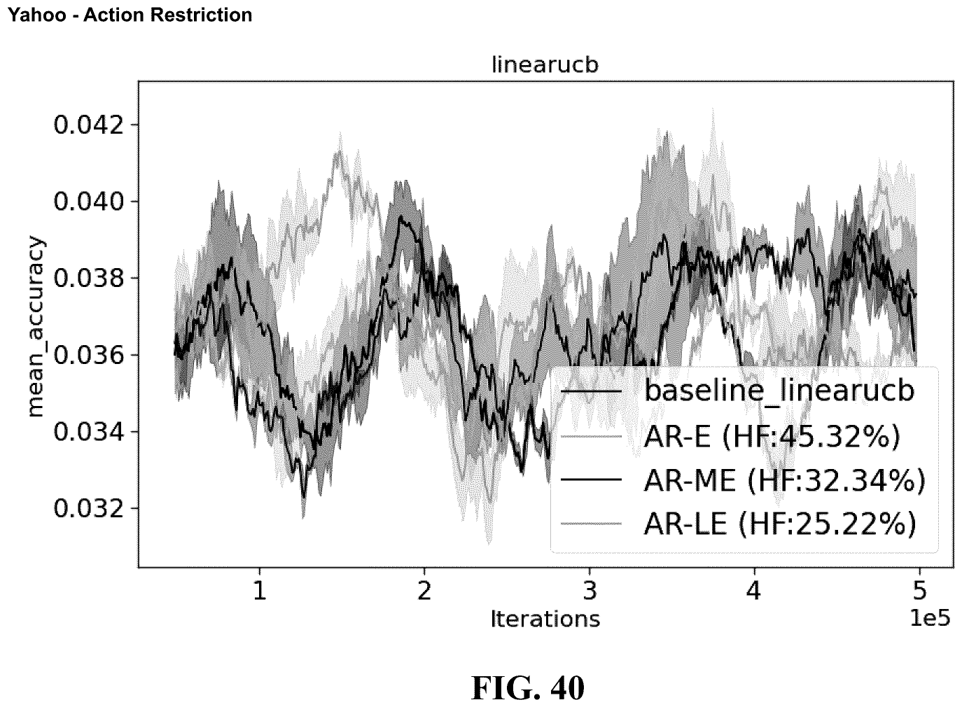

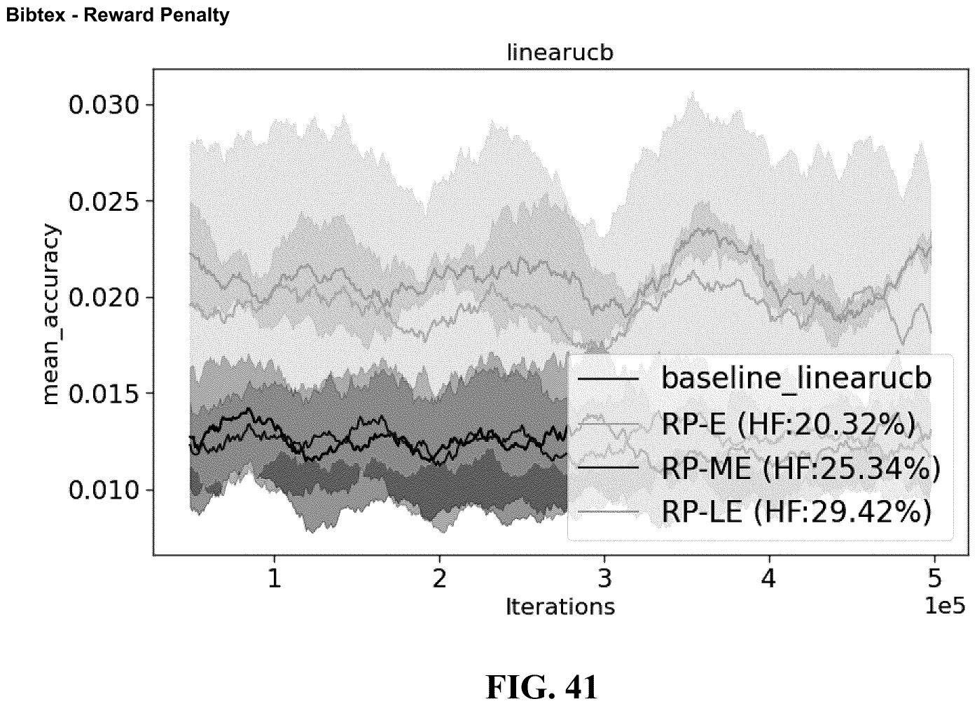

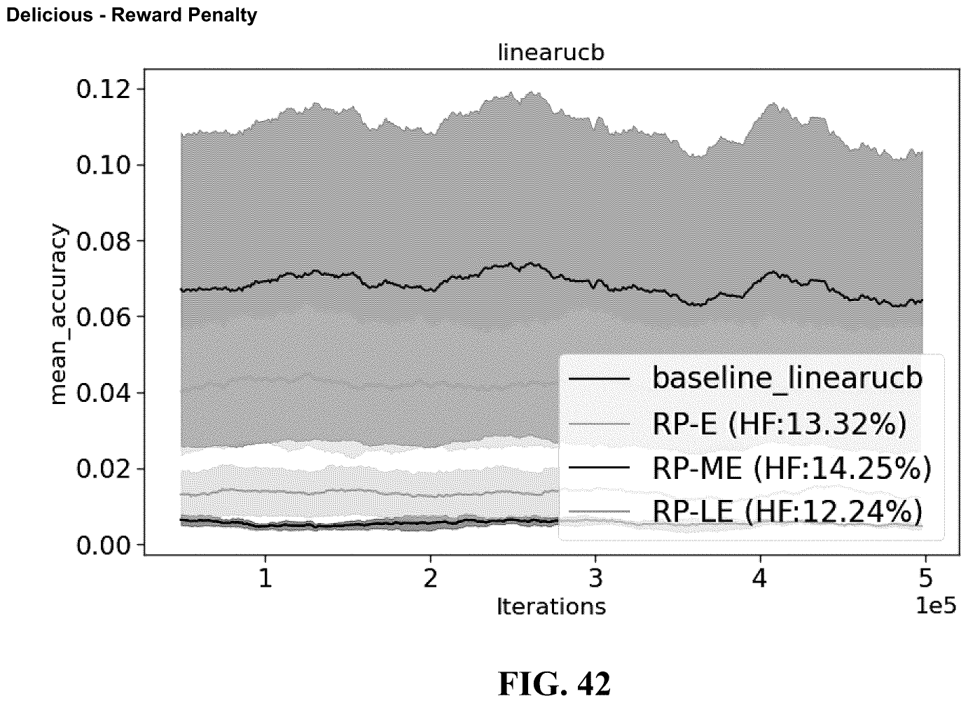

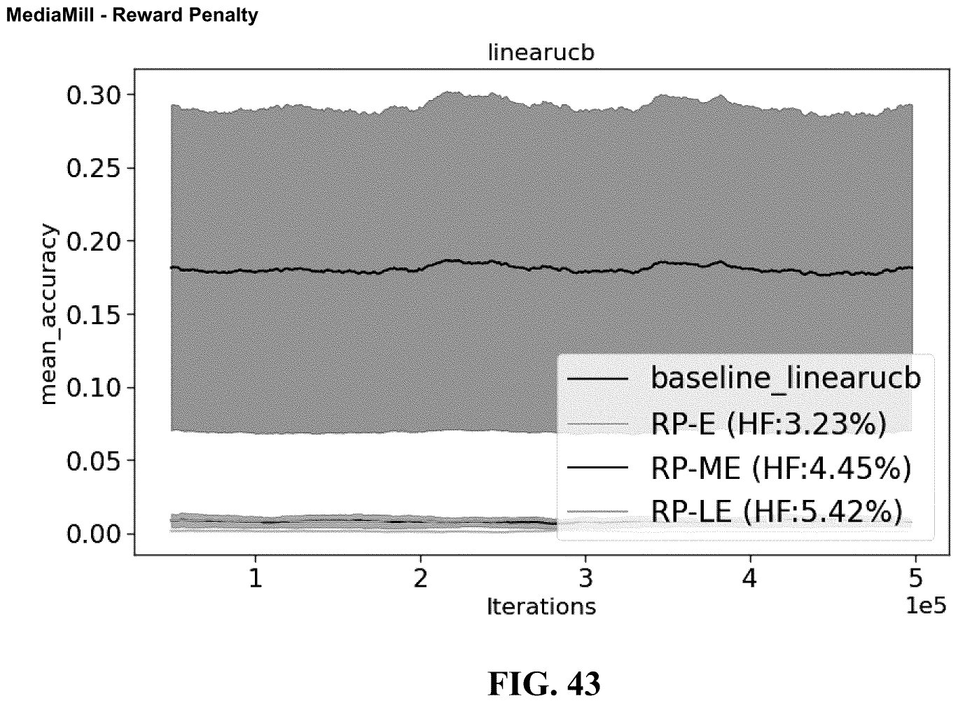

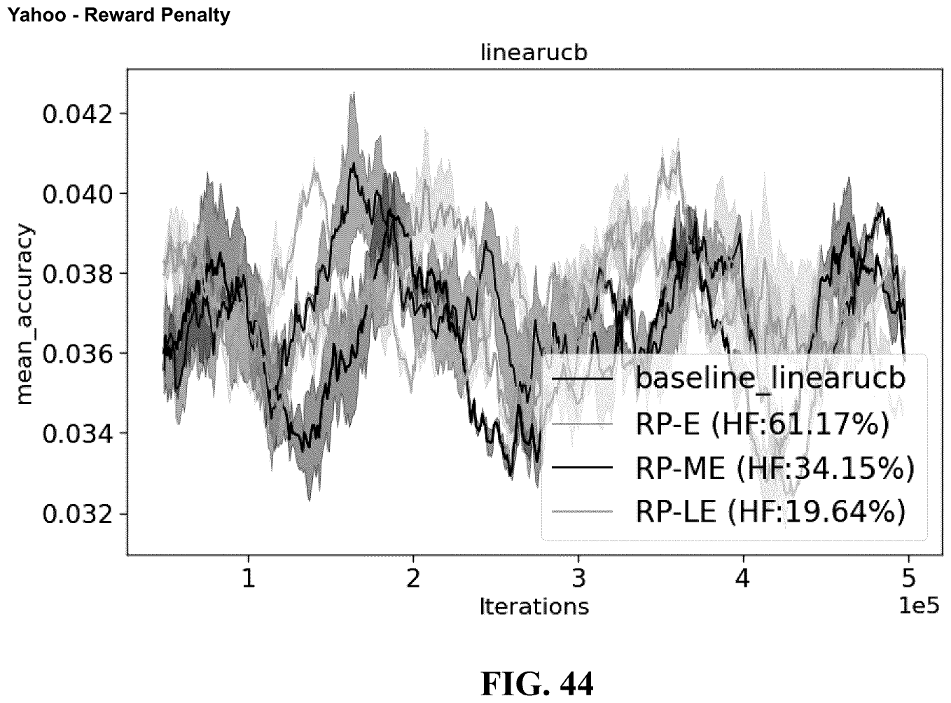

FIGS. 13-44 are plots illustrating the performance behavior of different algorithms across various datasets and feedback types. The plots highlight the percentage of the learning epoch during which each algorithm seeks human feedback, using optimal entropy thresholds.

TABLE 3
Model accuracy with entropy-based feedback

| | | | |
|---|---|---|---|
| bibtex | delicious | media_mill | yahoo |

PPO

| | | | | |
|---|---|---|---|---|
| baselines | 0.3148 ± 0.0341 | 0.3997 ± 0.0685 | 0.7797 ± 0.0337 | 0.034 ± 0.015 |
| AR-E | 0.6143 ± 0.0209 | 0.5512 ± 0.0275 | 0.7776 ± 0.0180 | 0.036 ± 0.009 |
| AR-ME | 0.6103 ± 0.0198 | 0.4616 ± 0.0327 | 0.7741 ± 0.1782 | 0.037 ± 0.001 |
| AR-LE | 0.5430 ± 0.0224 | 0.4626 ± 0.0518 | 0.7807 ± 0.0170 | 0.040 ± 0.008 |
| RP-E | 0.0741 ± 0.0662 | 0.2590 ± 0.0567 | 0.7784 ± 0.0180 | 0.037 ± 0.009 |
| RP-ME | 0.0738 ± 0.0609 | 0.3759 ± 0.0258 | 0.7805 ± 0.019 | 0.037 ± 0.008 |
| RP-LE | 0.1749 ± 0.0443 | 0.2932 ± 0.0593 | 0.7665 ± 0.0183 | 0.038 ± 0.007 |

PPO-LSTM

| | | | | |
|---|---|---|---|---|
| baselines | 0.2328 ± 0.0675 | 0.3827 ± 0.0370 | 0.7726 ± 0.0319 | 0.036 ± 0.014 |
| AR-E | 0.2605 ± 0.0210 | 0.3894 ± 0.0209 | 0.7699 ± 0.0185 | 0.038 ± 0.008 |
| AR-ME | 0.2710 ± 0.0227 | 0.3904 ± 0.0206 | 0.7726 ± 0.0215 | 0.036 ± 0.009 |
| AR-LE | 0.2961 ± 0.0187 | 0.3858 ± 0.0229 | 0.7759 ± 0.0186 | 0.037 ± 0.008 |
| RP-E | 0.1352 ± 0.0136 | 0.3681 ± 0.0272 | 0.7744 ± 0.0244 | 0.036 ± 0.009 |
| RP-ME | 0.1349 ± 0.0152 | 0.3743 ± 0.0229 | 0.7681 ± 0.0182 | 0.036 ± 0.007 |
| RP-LE | 0.1357 ± 0.0145 | 0.3730 ± 0.0291 | 0.7759 ± 0.0205 | 0.037 ± 0.008 |

Reinforce

| | | | | |
|---|---|---|---|---|
| baselines | 0.3479 ± 0.0356 | 0.4670 ± 0.0661 | 0.7782 ± 0.0352 | 0.039 ± 0.014 |
| AR-E | 0.5555 ± 0.0209 | 0.4605 ± 0.0177 | 0.7752 ± 0.0178 | 0.037 ± 0.007 |
| AR-ME | 0.5366 ± 0.0207 | 0.4390 ± 0.0474 | 0.7751 ± 0.0170 | 0.039 ± 0.009 |
| AR-LE | 0.5283 ± 0.0270 | 0.4362 ± 0.0377 | 0.7769 ± 0.0190 | 0.040 ± 0.009 |
| RP-E | 0.0768 ± 0.0608 | 0.4901 ± 0.0217 | 0.7733 ± 0.0206 | 0.038 ± 0.010 |
| RP-ME | 0.0812 ± 0.0587 | 0.4841 ± 0.0289 | 0.7761 ± 0.0203 | 0.035 ± 0.009 |
| RP-LE | 0.0814 ± 0.0627 | 0.5165 ± 0.0252 | 0.7757 ± 0.0192 | 0.037 ± 0.010 |

LinearUCB

| | | | | |
|---|---|---|---|---|
| baselines | 0.0124 ± 0.0094 | 0.0045 ± 0.0056 | 0.1826 ± 0.1802 | 0.0344 ± 0.0120 |
| AR-E | 0.0776 ± 0.0105 | 0.0337 ± 0.0082 | 0.0602 ± 0.0248 | 0.0387 ± 0.0088 |
| AR-ME | 0.0565 ± 0.0224 | 0.0906 ± 0.0483 | 0.0180 ± 0.0055 | 0.0376 ± 0.0083 |
| AR-LE | 0.0484 ± 0.0362 | 0.0191 ± 0.0165 | 0.3914 ± 0.3859 | 0.0357 ± 0.0099 |
| RP-E | 0.0181 ± 0.0121 | 0.0396 ± 0.0277 | 0.0015 ± 0.0011 | 0.0380 ± 0.0093 |
| RP-ME | 0.0117 ± 0.0054 | 0.0642 ± 0.0625 | 0.0077 ± 0.0053 | 0.0369 ± 0.0080 |
| RP-LE | 0.0226 ± 0.0066 | 0.0124 ± 0.0098 | 0.0088 ± 0.0041 | 0.0349 ± 0.0077 |

### Observed Differences Between Penalty Types

As shown in FIGS. 13-28, the two reward structures function differently with respect to the entropy threshold. As mentioned previously, action restriction, when compared to reward penalty, leads to a more consistent link between the quality of the feedback that is given and the model's resulting performance. A likely contributor to this is that the reward penalty interferes more with learning dynamics (as it directly impacts the loss).

### Conclusion

As can be seen, embodiments of the disclosure may be used to evaluate the performance of contextual bandits within the framework of human-in-the-loop reinforcement learning. By implementing two different types of feedback—action restriction and reward penalties—it can be seen that a range of contextual bandits benefit from such human feedback. To increase the effect that feedback can have on a contextual bandit's performance, an entropy-based criterion, aimed at balancing exploration and exploitation in the learning process, may be used to trigger the moduel's solicitation of the feedback. The results indicate that this entropy-based approach may significantly improve the model's performance.

According to some embodiments, instead of the model soliciting feedback based on entropy exceeding a threshold, feedback may be generated in response to a preset number of training epochs having expired.

Embodiments of the disclosure are therefore directed at methods of training a reinforcement learning machine learning model, such as a contextual bandit machine learning model, using any of the above-described methods. Embodiments of the disclosure are further directed at systems configured to train reinforcement learning machine learning models in such a manner, as well as computer-readable media storing reinforcement learning machine learning models trained in such a manner. Embodiments of the disclosure are further directed to the use of reinforcement learning machine learning models trained in such a manner. For example, the trained contextual bandit machine learning model may be used in a variety of different applications, such as in systems or platforms configured to generate personalized marketing offers, systems or platforms configured for fraud detection and prevention, and systems or platforms configured for customer retention and churn reduction. For instance, in the example context of a system configured to generate personalized marketing offers, the system may be configured to detect one or more user inputs (such as one or more mouse “clicks” initiated by the user). Based on the one or more user inputs, the trained contextual bandit may be used to generate one or more recommendations, such as one or more advertisements. The one or more recommendations may then be caused to be displayed on a user interface.

As can be seen from the above description, incorporating entropy-based feedback in the training of a contextual bandit model as described herein represents significantly more than merely using categories to organize, store and transmit information and organizing information through mathematical correlations. The incorporation of entropy-based feedback in the training is in fact an improvement to the technology of machine learning, as it provides for a machine learning model that may more consistently make accurate decisions given various different contexts/environments it is presented with. In particular, the incorporation of entropy-based feedback in the training represents an improvement to the baseline algorithm, or to the standard training procedure, for contextual bandit machine learning models. Moreover, although the technology can be applied across a wide range of scenarios, the particular scenario in which the technology is applied does not change the fundamental nature of the technology described and claimed herein, which is entirely confined to machine learning applications.

The present technology may be embodied within a system, a method, a computer program product or any combination thereof. The computer program product may include a computer-readable storage medium or media having computer-readable program instructions thereon for causing a processor to carry out aspects of the present technology. The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language or a conventional procedural programming language. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by using state information of the computer-readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the drawings illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer-readable program instructions may also be stored in a computer-readable storage medium that can direct a computer, other programmable data processing apparatus, or other devices to function in a particular manner, such that the instructions stored in the computer-readable storage medium produce an article of manufacture including instructions which implement aspects of the functions/acts specified in the flowchart and/or block diagram block or blocks. The computer-readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

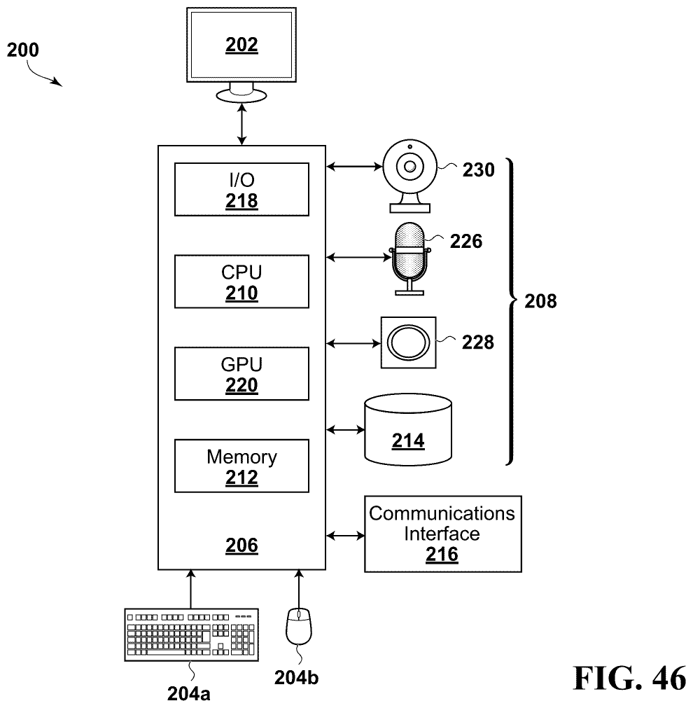

An illustrative computer system in respect of which the technology herein described may be implemented is presented as a block diagram in FIG. 46. The illustrative computer system is denoted generally by reference numeral 200 and includes a display 202, input devices in the form of keyboard 204a and pointing device 204b, computer 806 and external devices 208. While pointing device 204b is depicted as a mouse, it will be appreciated that other types of pointing device, or a touch screen, may also be used.

The computer 206 may contain one or more processors or microprocessors, such as a central processing unit (CPU) 210. The CPU 210 performs arithmetic calculations and control functions to execute software stored in an internal memory 212, preferably random-access memory (RAM) and/or read only memory (ROM), and possibly additional memory 214. The additional memory 214 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 214 may be physically internal to the computer 206, or external as shown in FIG. 46, or both.

The computer system 200 may also include other similar means for allowing computer programs or other instructions to be loaded. Such means can include, for example, a communications interface 216 which allows software and data to be transferred between the computer system 200 and external systems and networks. Examples of communications interface 216 can include a modem, a network interface such as an Ethernet card, a wireless communication interface, or a serial or parallel communications port. Software and data transferred via communications interface 216 are in the form of signals which can be electronic, acoustic, electromagnetic, optical or other signals capable of being received by communications interface 216. Multiple interfaces, of course, can be provided on a single computer system 200.

Input and output to and from the computer 206 is administered by the input/output (I/O) interface 218. This I/O interface 218 administers control of the display 202, keyboard 204a, external devices 208 and other such components of the computer system 200. The computer 206 also includes a graphical processing unit (GPU) 220. The latter may also be used for computational purposes as an adjunct to, or instead of, the (CPU) 210, for mathematical calculations.

The external devices 208 include a microphone 226, a speaker 228 and a camera 230. Although shown as external devices, they may alternatively be built in as part of the hardware of the computer system 200.

The various components of the computer system 200 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer-readable program code for implementing aspects of the technology described herein may be contained or stored in the memory 212 of the computer 206, or on a computer usable or computer-readable medium external to the computer 206, or on any combination thereof.

While the embodiments described herein have been generally described in the context of contextual bandits, the methods may be applied to any reinforcement learning problem in which human feedback can be requested, such as in online learning or active learning setups.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A method of using one or more computer processors to train a reinforcement learning machine learning model, comprising using the one or more computer processors to:
input a training dataset to the reinforcement learning machine learning model;
train the reinforcement learning machine learning model based on the training dataset;
determine, during the training, an entropy of the reinforcement learning machine learning model;
generate feedback based on the entropy; and
further train the reinforcement learning machine learning model based on the feedback.

2. The method of claim 1, wherein the reinforcement learning machine learning model is a contextual bandit machine learning model.

3. The method of claim 2, wherein, during the training, the contextual bandit machine learning model is configured to maximize the function
$${max}_{{u}_{t} ∼ π} {\sum }_{t = 1}^{T} 𝔼 [ {r}_{t} ( {u}_{t} ) \vert {s}_{t} , {u}_{t} ] ,$$
wherein E is the expected value, rₜ (uₜ) is a reward function at time t and which depends on an action uₜ, and sₜ is a state at time t.

4. The method of claim 1, wherein determining the entropy comprises:
determining a number of actions that may be selected by the reinforcement learning machine learning model and respective probabilities of the reinforcement learning machine learning model selecting each action; and
calculating H(p)=Σᵢpᵢ log₂ pᵢ, wherein H is the entropy and pᵢ is the probability of selecting the i^{th} action.

5. The method of claim 1, wherein generating the feedback comprises:
determining a threshold; and
in response to determining that the entropy has exceeded the threshold, generating the feedback.

6. The method of claim 1, wherein generating the feedback comprises:
determining a total number of actions that may be selected by the reinforcement learning machine learning model; and
restricting the total number of actions that may be selected by the reinforcement learning machine learning model.

7. The method of claim 6, wherein restricting the total number of actions comprises restricting the number of actions that may be selected by the reinforcement learning machine learning model to a number q of actions, wherein q is less than or equal to the number of actions that may be selected divided by 2.

8. The method of claim 1, wherein generating the feedback comprises:
determining that the reinforcement learning machine learning model has selected an action from among a number of different possible actions, including one or more recommended actions;
determining that the selected action is not a recommended action; and
in response to determining that the selected action is not a recommended action, applying a reward penalty to a reward signal of the reinforcement learning machine learning model.

9. The method of claim 8, wherein applying the reward penalty comprises reducing a reward that would otherwise have been applied to the reward signal in response to determining that the selected action is a recommended action.

10. The method of claim 1, wherein:
generating the feedback comprises:
determining an accuracy level to be associated with the feedback; and
generating the feedback based on the accuracy level,
and in response to generating the feedback:
the reinforcement learning machine learning model selects an action from among a number of different possible actions; and
a reward generated based on the selected action is more likely to be higher when the accuracy level associated with the feedback is relatively higher than when the accuracy level associated with the feedback is relatively lower.

11. The method of claim 1, wherein generating the feedback comprises:
during the training, determining a number of different possible actions that may be selected by the reinforcement learning machine learning model;
inputting the different possible actions to a neural network trained to generate feedback based on different possible actions; and
generating the feedback using the trained neural network.

12. The method of claim 11, wherein the trained neural network is a trained multi-layer perceptron.

13. A non-transitory, computer-readable storage medium storing computer program code configured, when executed by one or more processors, to cause the one or more processors to train a reinforcement learning machine learning model by performing the steps of claim 1.

14. A method of using a reinforcement learning machine learning model, wherein the reinforcement learning machine learning model has been trained according to claim 1.

15. The method of claim 14, wherein using the reinforcement learning machine learning model comprises:
detecting one or more user inputs;
using the trained reinforcement learning machine learning model to generate, based on the one or more user inputs, one or more advertisements; and
causing the one or more advertisements to be displayed on a user interface.

16. A method of using one or more computer processors to train a contextual bandit machine learning model, comprising using the one or more computer processors to:
input a training dataset to the contextual bandit machine learning model;
train the contextual bandit machine learning model based on the training dataset;
generate feedback during the training; and
further train the contextual bandit machine learning model based on the feedback.

17. The method of claim 16, wherein generating the feedback comprises:
determining that one or more training epochs have expired; and
in response to determining that the one or more training epochs have expired, generating the feedback.

18. The method of claim 16, wherein generating the feedback comprises:
determine, during the training, an entropy of the contextual bandit machine learning model; and
generate the feedback based on the entropy.
